(19) United States
(12) Patent Application Publication
(10) Pub. No.: US 2019/0368971 A1
(43) Pub. Date: Dec. 5, 2019

(54) FINE PARTICLE DETECTION SYSTEM

(71) Applicant: NGK SPARK PLUG CO., LTD., Nagoya, Aichi (JP)

(72) Inventors: Masayuki MOTOMURA, Komaki-shi (JP); Norimasa OSAWA, Inuyama-shi (JP)

(21) Appl. No.: 16/071,339

(22) PCT Filed: Sep. 27, 2016
(86) PCT No.: PCT/JP2016/004347

§ 371 Date: Jul. 19, 2018

(30) Foreign Application Priority Data
Feb. 1, 2016 (JP) 2016-017370

(51) Int. Cl. G01M 15/10; G01N 15/06

(52) U.S. Cl. CPC G01M 15/102; G01N 2015/0046; G01N 15/0656

(57) ABSTRACT

A fine particle detection system which can appropriately detect the amount of fine particles contained in a gas under measurement is provided. In the case where it is determined by insulation test means 221, 230 that the degree of insulation does not fall within the allowable range, heater energization means 221, 223 performs heater energization (S5 to S7) for energizing a heater 105 to thereby heat a gas contact portion 100s. In the case where it is determined by the insulation test means without performance of the heater energization that the degree of insulation falls within the allowable range, sensor drive means 210, 221, 240 drives a fine particle sensor 10 after that (step S3). In the case where the heater energization is performed and the sensor drive means drives the fine particle sensor after that, the sensor drive means drives the fine particle sensor after a certain cooling time tc or a cooling time set in accordance with the conditions of the energization of the heater by the heater energization elapses after completion of the heater energization.

### TECHNICAL FIELD

The present invention relates to a fine particle detection system, in particular, to a fine particle detection system for detecting fine particles contained in a gas under measurement flowing through a gas flow pipe.

### BACKGROUND ART

Exhaust gas discharged from an internal combustion engine (for example, a diesel engine) may contain fine particles such as soot. Exhaust gas containing such fine particles is cleaned by collecting the fine particles with a filter. Also, when necessary, the filter is heated to a high temperature so as to burn and remove fine particles accumulated in the filter. Therefore, when a malfunction of the filter such as breakage thereof occurs, uncleaned exhaust gas is discharged directly to the downstream side of the filter. In view of this, for direct measurement of the amount of fine particles contained in the exhaust gas or detection of the malfunction of the filter, there has been demand for a fine particle detection system capable of detecting the amount of fine particles contained in exhaust gas.

Such a fine particle detection system includes, for example, a fine particle sensor attached to an exhaust pipe maintained at a ground potential, and sensor drive means for driving the fine particle sensor. The fine particle sensor includes, for example, an inner metallic member having a gas introduction pipe, an outer metallic member, and an insulating spacer. The inner metallic member is a member which is maintained at a first potential different from the ground potential and which introduces exhaust gas into the gas introduction pipe. The outer metallic member is a tubular member which surrounds the radially outer circumference of the inner metallic member and which is attached to the exhaust pipe to thereby be maintained at the ground potential. Also, the insulating spacer is a tubular member which is interposed between the inner metallic member and the outer metallic member so as to electrically insulate them from each other. This insulating spacer has a gas contact portion including a gas contact surface which comes into contact with the exhaust gas flowing through the exhaust pipe. Such a fine particle detection system is disclosed in, for example, Patent Documents 1 and 2.

### PRIOR ART DOCUMENTS

### Patent Documents

Patent Document 1: Japanese Patent Application Laid-Open (kokai) No. 2014-10099
Patent Document 2: Japanese Patent Application Laid-Open (kokai) No. 2015-129712

### SUMMARY OF THE INVENTION

### Problem to be Solved by the Invention

As described above, at the gas contact surface, the insulating spacer comes into contact with the exhaust gas flowing through the exhaust pipe. Therefore, foreign substances (for example, water, soot, or the like) contained in the exhaust gas may adhere to the gas contact surface of the insulating spacer. As a result of adhesion of such foreign substances to the gas contact surface, the insulation performance of the insulating spacer deteriorates, and the insulation between the inner metallic member maintained at the first potential and the outer metallic member maintained at the ground potential deteriorates, which may result in a failure to appropriately detect the amount of fine particles contained in the exhaust gas.

The present invention has been accomplished in view of the present situation, and its object is to provide a fine particle detection system which can appropriately detect the amount of fine particles contained in a gas under measurement.

### Means for Solving the Problem

One mode of the present invention is a fine particle detection system for detecting fine particles contained in a gas under measurement flowing through a gas flow pipe, comprising a fine particle sensor to be attached to the gas flow pipe maintained at a ground potential; and sensor drive means for driving the fine particle sensor. The fine particle sensor comprises a tubular outer metallic member attached to the gas flow pipe to thereby be maintained at the ground potential, an inner metallic member which is maintained at a first potential different from the ground potential and whose radially outer circumference is surrounded by the outer metallic member, and a tubular insulating spacer disposed between the inner metallic member and the outer metallic member so as to electrically insulate the members from each other. The insulating spacer includes a gas contact portion having a gas contact surface which comes into contact with the gas under measurement flowing through the gas flow pipe, and a heater for heating the gas contact portion. The heater includes a heat generation resistor embedded in the insulating spacer. The fine particle detection system comprises insulation test means for determining, through testing, whether or not the degree of insulation between the inner metallic member and the outer metallic member falls within an allowable range, and heater energization means for energizing the heater to thereby cause the heat generation resistor to generate heat. In the case where it is determined by the insulation test means that the degree of insulation does not fall within the allowable range, the heater energization means performs heater energization for energizing the heater to thereby heat the gas contact portion. In the case where it is determined by the insulation test means without performance of the heater energization that the degree of insulation falls within the allowable range, the sensor drive means drives the fine particle sensor after the determination. In the case where the heater energization is performed and the sensor drive means drives the fine particle sensor after the heater energization, the sensor drive means drives the fine particle sensor after a certain cooling time or a cooling time set in accordance with conditions of the energization of the heater by the heater energization elapses after completion of the heater energization.

In the above-described fine particle detection system, the insulation test means determines whether or not the degree of insulation between the inner metallic member and the outer metallic member falls within the allowable range. Specifically, for example, a predetermined voltage is applied between the inner metallic member and the outer metallic member, the magnitude of leak current flowing between the inner metallic member and the outer metallic member is measured, and a determination is made as to whether or not the magnitude of the leak current falls within the allowable range (for example, whether or not the magnitude of the leak current is less than a threshold value set in advance). In this case, the “degree of insulation” is represented by the magnitude of the leak current.

Notably, the allowable range for the degree of insulation between the inner metallic member and the outer metallic member is set to a range of the degree of insulation within which the amount of fine particles contained in the gas under measurement can be detected appropriately by the fine particle detection system. In the case where foreign substances (water, soot, etc.) have adhered to the gas contact surface of the insulating spacer, since the degree of insulation between the inner metallic member and the outer metallic member is low, the degree of insulation between the two members may be determined not to fall within the allowable range.

Further, in the above-described fine particle detection system, in the case where it is determined by the insulation test means that the degree of insulation does not fall within the allowable range, the heater energization means performs the heater energization for energizing the heater to thereby heat the gas contact portion. As a result, the foreign substances (water, soot, etc.) having adhered to the gas contact surface are removed, whereby the insulation properties of the insulating spacer (the insulation properties of the gas contact surface) having deteriorated as a result of adhesion of the foreign substances to the gas contact surface are recovered.

However, when the above-described heater energization is performed, since the temperature of the insulating spacer elevates, the volume resistivity (volume specific resistance) of the insulating spacer decreases. Therefore, immediately after performance of the above-described heater energization, the insulating spacer may fail to appropriately provide electrical insulation between the inner metallic member and the outer metallic member. In such a case, if the amount of the fine particles contained in the gas under measurement is detected by driving the fine particle sensor after the heater energization, there arises a possibility that the amount of the fine particles contained in the gas under measurement cannot be detected appropriately.

In view of this, in the above-described fine particle detection system, in the case where the fine particle sensor is driven by the sensor drive means after performance of the above-described heater energization, the fine particle sensor is driven upon elapse of a certain cooling time after the end of the heater energization. Alternatively, in the case where the fine particle sensor is driven by the sensor drive means after performance of the above-described heater energization, the fine particle sensor is driven upon elapse of a cooling time, which is set in accordance with the conditions of the energization of the heater by the heater energization, after the end of the heater energization.

As a result of elapse of the “certain cooling time” or the “cooling time set in accordance with the conditions of the energization of the heater” after the end of the heater energization, the temperature of the insulating spacer drops, whereby the volume resistivity (volume specific resistance) of the insulating spacer can be recovered. As a result, the insulating spacer can appropriately provide electrical insulation between the inner metallic member and the outer metallic member. By driving the fine particle sensor after that, the amount of the fine particles contained in the gas under measurement can be detected appropriately.

Meanwhile, in the case where it is determined by the insulation test means, without performance of the above-described heater energization, that the degree of insulation falls within the allowable range, the sensor drive means drives the fine particle sensor after the determination. As a result, the amount of the fine particles contained in the gas under measurement can be detected appropriately. Notably, the “certain cooling time” is preferably set to, for example, a time within which the temperature of the insulating spacer having elevated due to the heater energization is expected to drop to the temperature before performance of the heater energization.

Also, examples of the “cooling time set in accordance with the conditions of the energization of the heater by the heater energization” are as follows.

For example, in the case where a plurality of types of heater energization operations which differ in the conditions of energization of the heater are performed as the heater energization, examples of the cooling time are cooling times set for the plurality of types of heater energization operations. Specifically, examples of the cooling time are first and second cooling times set for first and second heater energizations in a fine particle detection system “in which when the insulation test means determines that the degree of insulation between the inner metallic member and the outer metallic member does not fall within the allowable range, the heater energization means first performs heater energization (first heater energization) for raising the temperature of the heater to a temperature at which water having adhered to the gas contact surface is removed (for example, a temperature within the range of 100° C. to 150° C.) after the end of this first heater energization, the insulation test means again determines whether or not the degree of insulation falls within the allowable range; and when the insulation test means determines that the degree of insulation does not fall within the allowable range, the heater energization means performs heater energization (second heater energization) for raising the temperature of the heater to a temperature for removal of foreign substances (soot, etc.) which have adhered to the gas contact surface and cannot be removed by the above-mentioned first heater energization (for example, a temperature within the range of 500° C. to 600° C.).”

Since the first heater energization and the second heater energization differ from each other in terms of the conditions of energization of the heater (for example, the duty ratio in the case of energization of the heater by PWM control), the temperature of the insulating spacer after the first heater energization and the temperature of the insulating spacer after the second heater energization differ from each other. Therefore, for example, the cooling times for the first and second heater energizations are set in advance in accordance with temperatures (expected temperatures) of the insulation spacer after the first and second heater energizations, and the fine particle sensor is driven upon elapse of each cooling time. Notably, each of the cooling times (first and second cooling times) is preferably set to a time within which the temperature of the insulating spacer having elevated due to the heater energization (first or second heater energization) is expected to drop to the temperature before performance of the heater energization.

Notably, the “cooling time set in accordance with the conditions of the energization of the heater by the heater energization” may be “0.” For example, in the case where the insulating spacer can appropriately provide electrical insulation between the inner metallic member and the outer metallic member even when the first heater energization raises the temperature of the insulating spacer, thereby decreasing the volume resistivity (volume specific resistance) of the insulating spacer, the fine particle detection can be performed appropriately even when the fine particle sensor is driven immediately after the first heater energization without waiting for elapse of the cooling time. Therefore, in such a case, the first cooling time for the first heater energization can be set to “0.”

Further, in the above-described fine particle detection system, preferably, the fine particle sensor generates gaseous discharge as a result of being driven by the sensor drive means, causes ions generated by means of the gaseous discharge to adhere to the fine particles contained in the gas under measurement to thereby produce electrified fine particles, and detects the amount of the fine particles contained in the gas under measurement through use of a signal current flowing between the first potential and the ground potential in accordance with the amount of the electrified fine particles.

In the above-described fine particle detection system, since the amount of fine particles contained in the gas under measurement is detected by using a signal current flowing in accordance with the amount of the above-mentioned electrified fine particles, the signal current is very small. Incidentally, when the insulation properties of the gas contact surface of the insulating spacer deteriorate as a result of adhesion of foreign substances (water, soot, etc.) to the gas contact surface, through the gas contact surface, leak current may flow between the inner metallic member maintained at the first potential and the outer metallic member maintained at the ground potential. Also, when the temperature of the insulating spacer increases as a result of performance of the above-described heater energization whereby the volume resistivity (volume specific resistance) of the insulating spacer decreases, leak current may flow between the inner metallic member and the outer metallic member through the interior of the insulating spacer. When the amount of this leak current is large, the amount of the signal current cannot be detected properly.

In view of this, in the above-described fine particle detection system, as described above, in the case where it is determined that the degree of insulation between the inner metallic member and the outer metallic member falls within the allowable range, the detection of the amount of fine particles is performed.

Meanwhile, in the case where it is determined that the degree of insulation between the inner metallic member and the outer metallic member does not fall within the allowable range, foreign substances are removed from the gas contact surface by performing the heater energization, and upon elapse of the cooling time after the heater energization, the detection of the amount of fine particles is performed.

As a result, in the above-described fine particle detection system, the amount of the small signal current can be detected appropriately without receiving the influence of the above-described leak current. Therefore, the amount of fine particles contained in the gas under measurement can be detected appropriately.

Further, in any of the above-described fine particle detection systems, preferably, the gas flow pipe is an exhaust pipe of an internal combustion engine, the gas under measurement is exhaust gas, and the insulation test means determines whether or not the degree of insulation between the inner metallic member and the outer metallic member falls within the allowable range in a period between a time when operation of the internal combustion engine is started and a time when the drive of the fine particle sensor by the sensor drive means is started.

According to the above-described fine particle detection system, after the operation of the internal combustion engine is started, the amount of fine particles contained in exhaust gas discharged from the internal combustion engine can be detected appropriately.

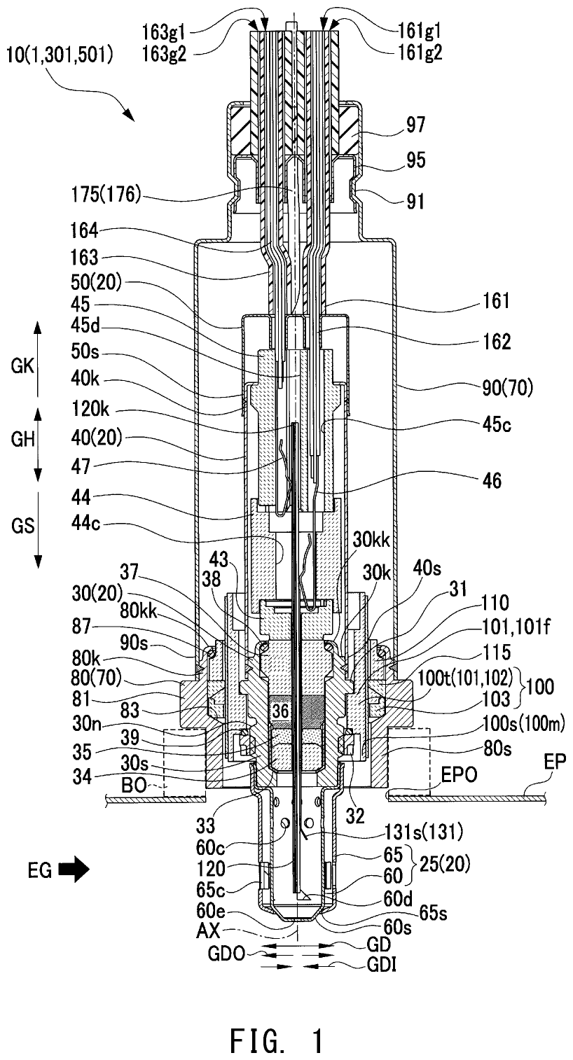

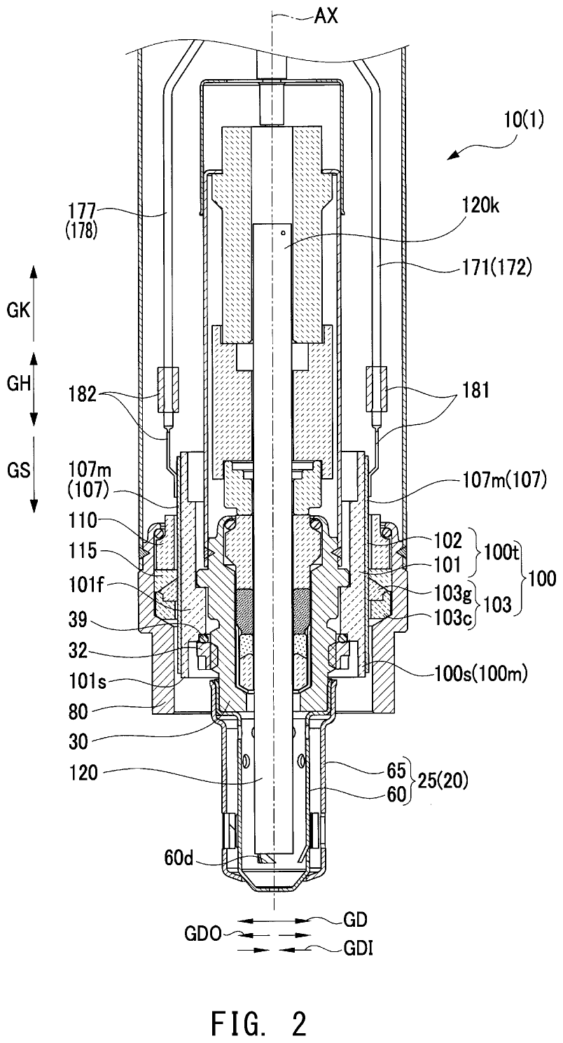

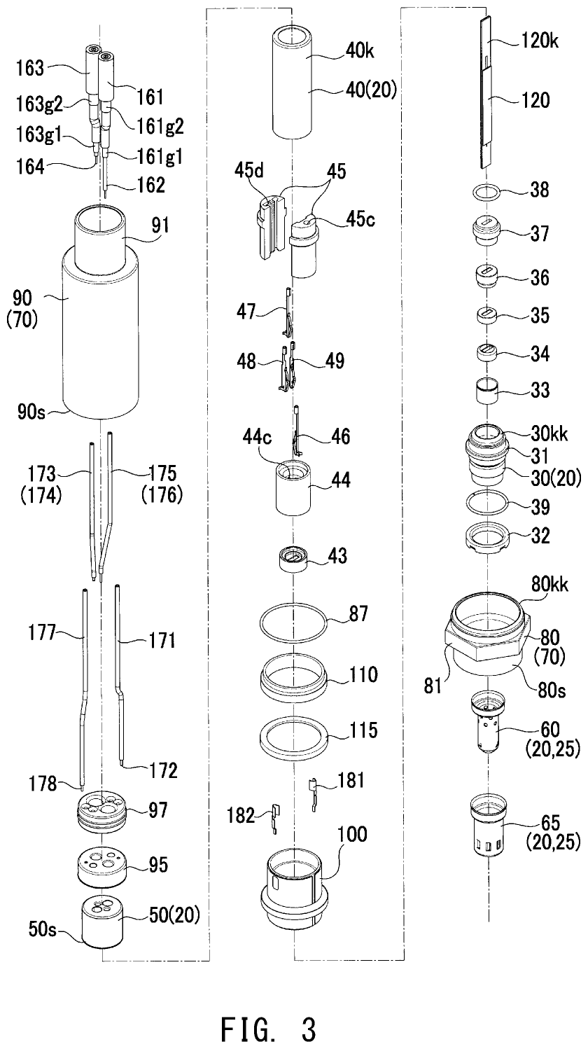

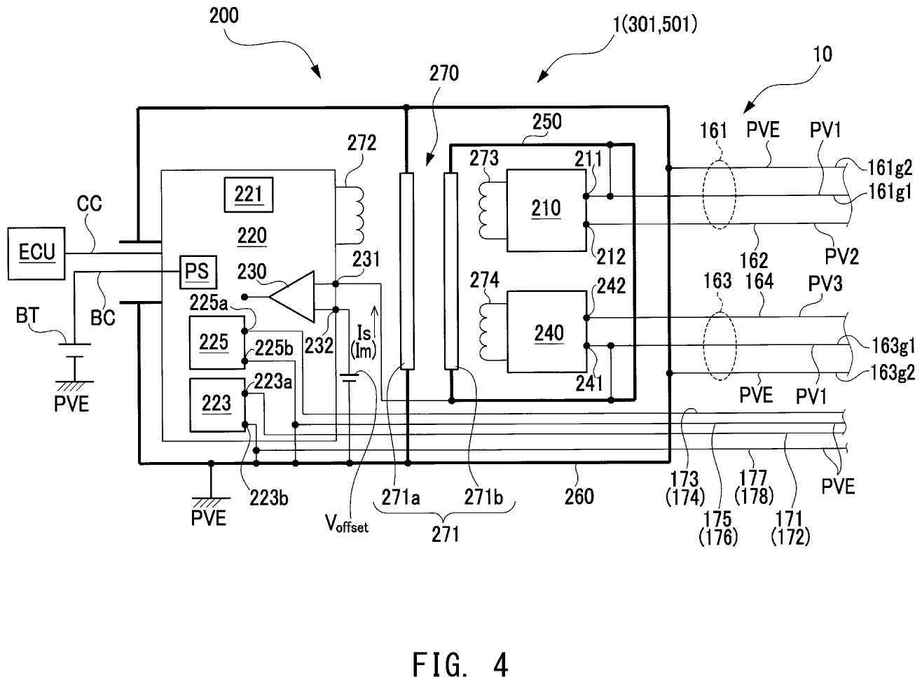

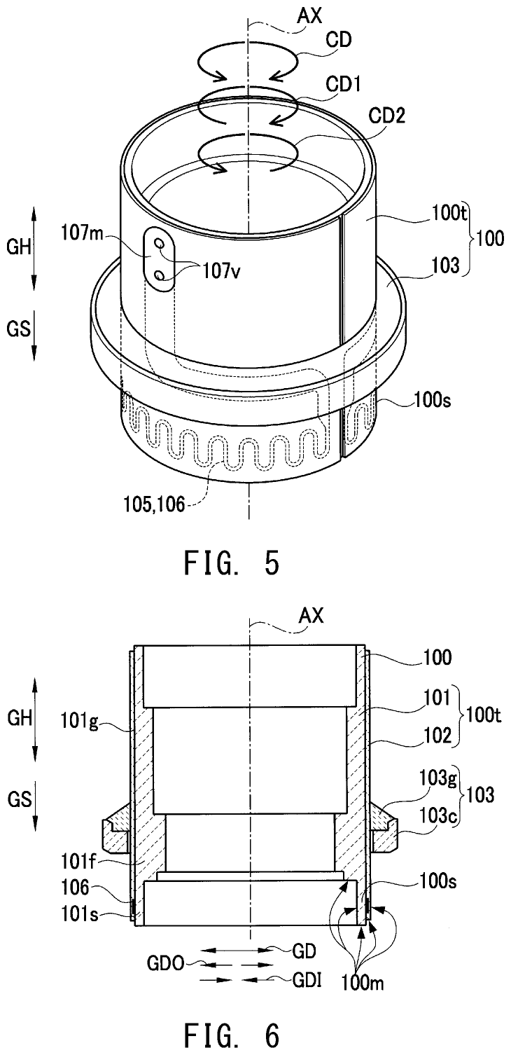

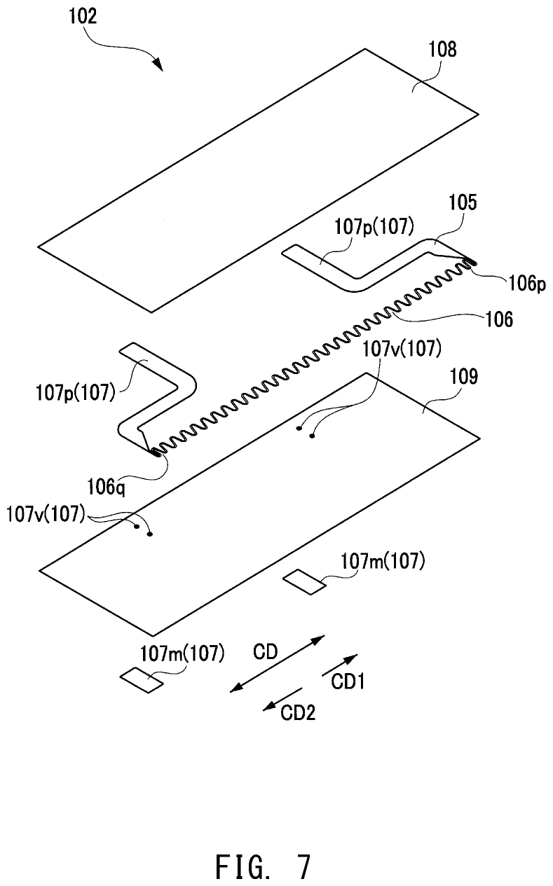

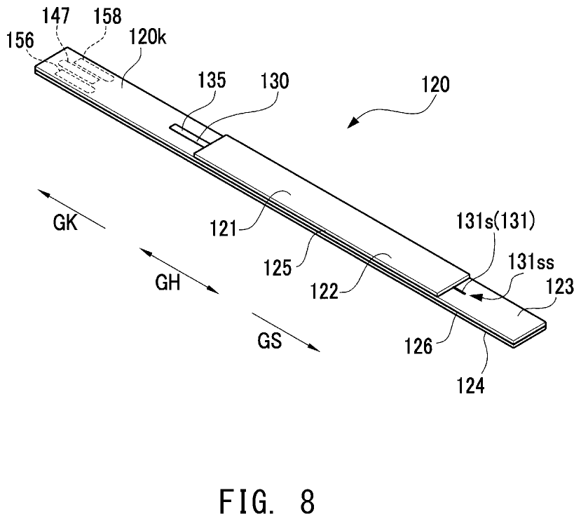

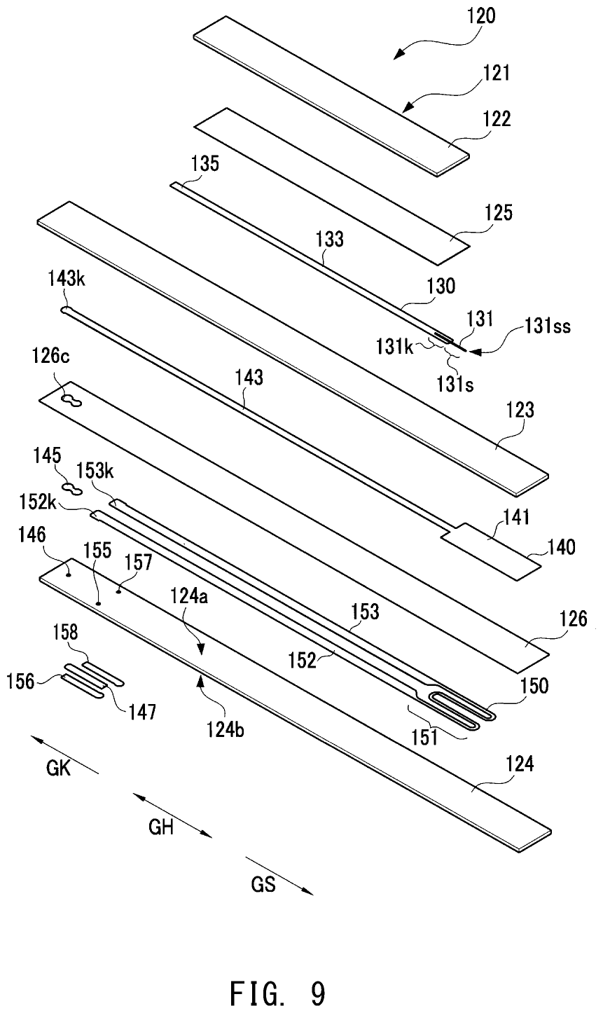

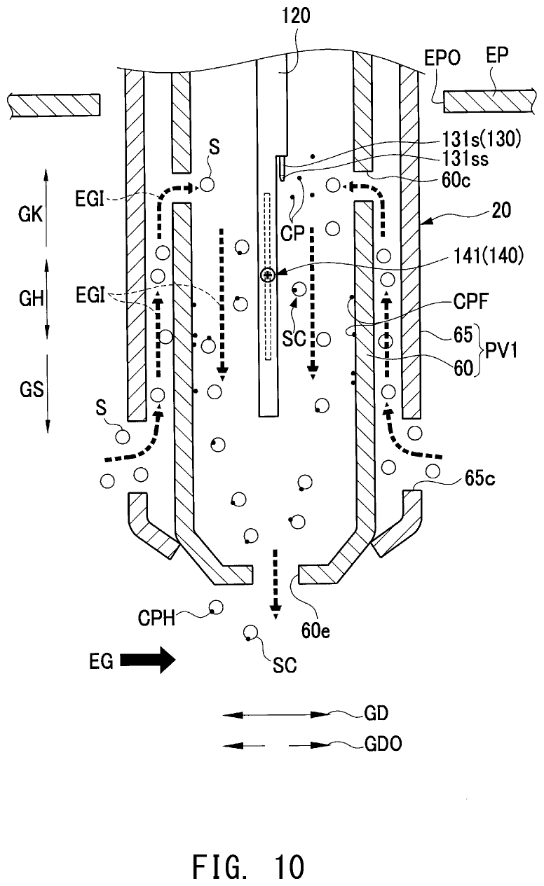

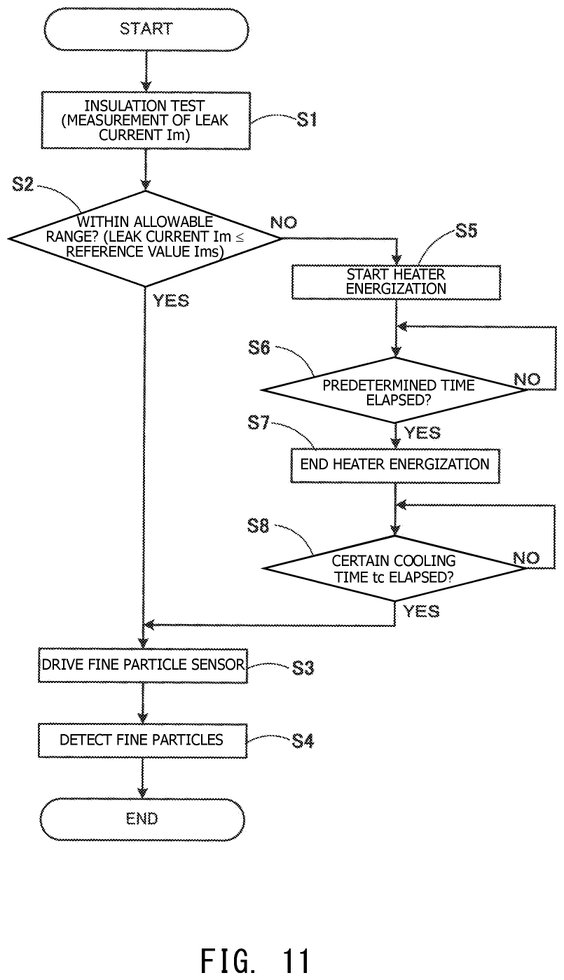

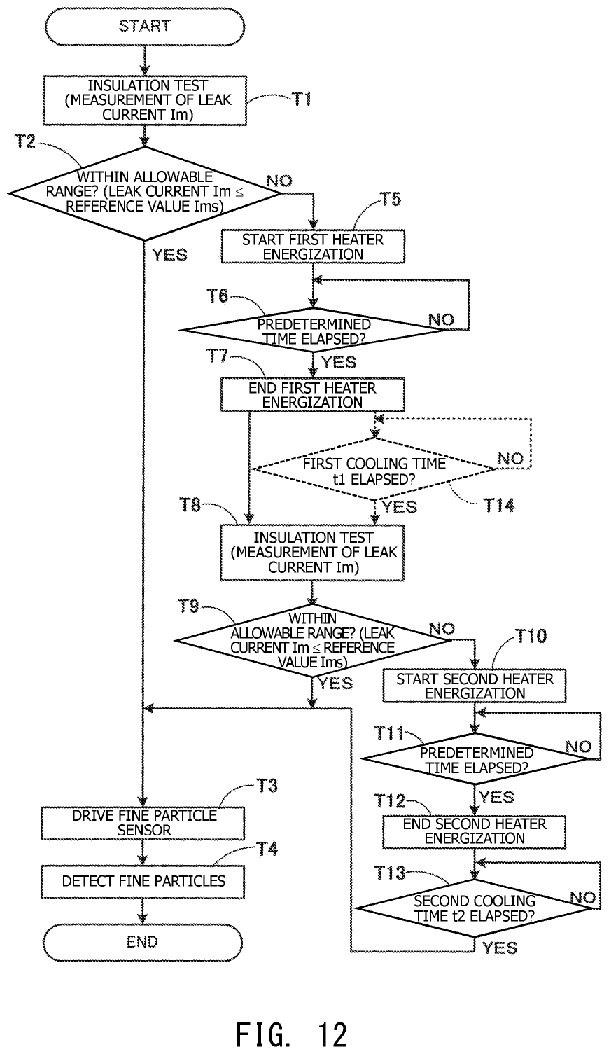

### BRIEF DESCRIPTION OF THE DRAWINGS

[FIG. 1] Longitudinal sectional view of a fine particle sensor according to Embodiment 1.

[FIG. 2] Enlarged longitudinal sectional view of the fine particle sensor as viewed from a side circumferentially offset from the view point of FIG. 1 by 90 degrees about its axial line.

[FIG. 3] Exploded perspective view of the fine particle sensor according to Embodiment 1.

[FIG. 4] Schematic diagram of a fine particle detection system according to Embodiment 1.

[FIG. 5] Perspective view of an insulating spacer according to Embodiment 1.

[FIG. 6] Longitudinal sectional view of the insulating spacer.

[FIG. 7] Exploded perspective view showing, in a developed state, a laminar heater portion of the insulating spacer.

[FIG. 8] Perspective view of a ceramic element according to Embodiment 1.

[FIG. 9] Exploded perspective view of the ceramic element.

[FIG. 10] Explanatory view of the fine particle sensor according to Embodiment 1.

[FIG. 11] Flowchart showing the flow of fine particle detection according to Embodiment 1.

[FIG. 12] Flowchart showing the flow of fine particle detection according to Embodiment 2 and Modification 1.

### MODES FOR CARRYING OUT THE INVENTION

### Embodiment 1

Embodiment 1 of the present invention will now be described with reference to the drawings. FIG. 1 is a longitudinal sectional view of a fine particle sensor 10 contained in a fine particle detection system 1 according to the present Embodiment 1. FIG. 2 is an enlarged longitudinal sectional view of the fine particle sensor 10 as viewed from a side circumferentially offset from the view point of FIG. 1 by 90 degrees about its axial line AX. FIG. 3 is an exploded perspective view of the fine particle sensor 10. FIG. 4 is a schematic diagram of the fine particle detection system 1 according to Embodiment 1. Notably, in FIG. 4, a circuit section 200 contained in the fine particle detection system 1 is mainly shown, and, as to the fine particle sensor 10, only a portion (electric wires 161, etc.) is shown.

Notably, in FIG. 1, in a longitudinal direction GH of the fine particle sensor 10 along the axial line AX, a side (lower side in FIG. 1) on which a gas introduction pipe 25 is disposed will be referred to as a distal end side GS, and a side (upper side in FIG. 1) which is opposite the distal end side GS and on which electric wires 161, 163, etc., extend will be referred to as a proximal end side GK.

The fine particle detection system 1 detects the amount of fine particles S (soot, etc.) contained in exhaust gas (gas under measurement) EG flowing through an exhaust pipe (gas flow pipe) EP of an internal combustion engine (engine). This fine particle detection system 1 is composed of the fine particle sensor 10 and the circuit section 200 (see FIGS. 1 and 4).

First, the fine particle sensor 10 will be described. The fine particle sensor 10 is attached to the exhaust pipe EP, which is formed of metal and is maintained at a ground potential PVE (see FIG. 1). Specifically, the gas introduction pipe 25 which forms a distal end portion of an inner metallic member 20 of the fine particle sensor 10 is disposed within the exhaust pipe EP through a mounting opening EPO provided in the exhaust pipe EP. Ions CP are caused to adhere to the fine particles S contained in an introduced gas EGI introduced into the gas introduction pipe 25 through gas introduction openings 65c (the introduced gas EGI being a portion of the exhaust gas EG flowing through the exhaust pipe EP) to thereby produce electrified fine particles SC, and the electrified fine particles SC, together with the introduced gas EGI, are discharged into the exhaust pipe EP through a gas discharge opening 60e (see FIG. 10).

The fine particle sensor 10 is composed of the inner metallic member 20 having the gas introduction pipe 25, an outer metallic member 70, an insulating spacer 100, a ceramic element 120, six electric wires 161, 163, 171, 173, 175, and 177, etc. (see FIGS. 1 to 3).

Of these members, the inner metallic member 20 electrically communicates with an inner circuit case 250 maintained at a first potential PV1, etc., of the circuit section 200 (to be described later) through inner-side outer conductors 161g1 and 163g1 of the electric wires 161 and 163 (to be described later) to thereby be maintained at the first potential PV1 different from the ground potential PVE. The inner metallic member 20 is composed of a metallic shell 30, an inner tube 40, an inner-tube metal connection member 50, and the gas introduction pipe 25 (an inner protector 60 and an outer protector 65).

The metallic shell 30 is a cylindrical stainless steel member extending in the longitudinal direction GH. The metallic shell 30 has an annular flange 31 projecting radially outward. A metal cup 33 is disposed within the metallic shell 30. The metal cup 33 has a hole formed in its bottom wall, and the ceramic element 120, which will be described later, extends through the hole.

In the interior of the metallic shell 30, around the ceramic element 120, a cylindrical ceramic holder 34 formed of alumina, first and second powder charged layers 35 and 36 formed by compressing powder of talc, and a cylindrical ceramic sleeve 37 formed of alumina are disposed in this order from the distal end side GS toward the proximal end side GK. Notably, the ceramic holder 34 and the first powder charged layer 35 are located within the metal cup 33. Further, a crimp portion 30kk, located furthest toward the proximal end side GK, of the metallic shell 30 is crimped toward a radially inward side, thereby pressing the ceramic sleeve 37 toward the distal end side GS through a crimp ring 38.

Also, the metallic shell 30 has a male screw portion 30n between the flange portion 31 and a distal end portion 30s. A spacer locking ring 32 for locking an insulating spacer 100 (to be described later) via a line packing 39 is brought into screw engagement with the male screw portion 30n. As a result, a thick wall portion 101f of a spacer body 101 of the insulating spacer 100 is sandwiched between the flange portion 31 of the metallic shell 30 and the spacer locking ring 32. Thus, as will be described later, in addition to the metallic shell 30, the ceramic element 120, etc. held by the metallic shell 30 are fixed to the metallic attachment member 80 via the insulating spacer 100.

The inner tube 40 is a cylindrical stainless steel member extending in the longitudinal direction GH. A distal end portion 40s of the inner tube 40 is fitted onto a proximal end portion 30k of the metallic shell 30 and is laser-welded to the proximal end portion 30k.

In the interior of the inner tube 40, an insulating holder 43, a first separator 44, and a second separator 45 are disposed in this order from the distal end side GS toward the proximal end side GK. The insulating holder 43 is formed of a cylindrical insulating member and comes into contact with the ceramic sleeve 37 from the proximal end side GK. The ceramic element 120 extends through the insulating holder 43.

Also, the first separator 44 is formed of an insulating member and has an insertion hole 44c. The insertion hole 44c allows the ceramic element 120 to extend therethrough and accommodates a distal end portion of a discharge potential terminal 46 therein. Within the insertion hole 44c, the discharge potential terminal 46 is in contact with a discharge potential pad 135 (see FIGS. 8 and 9) of the ceramic element 120.

Meanwhile, the second separator 45 is formed of an insulating member and has a first insertion hole 45c and a second insertion hole 45d. A proximal end portion of the discharge potential terminal 46 accommodated within the first insertion hole 45c, and a distal end portion of a discharge potential lead wire 162 (to be described later) are connected to each other within the first insertion hole 45c.

Also, within the second insertion hole 45d, an element proximal-end portion 120k of the ceramic element 120 is disposed; further, an auxiliary potential terminal 47, a 2-1 heater terminal 48, and a 2-2 heater terminal 49 are accommodated in a mutually insulated condition. Also, within the second insertion hole 45d, the auxiliary potential terminal 47 is in contact with an auxiliary potential pad 147 of the ceramic element 120; the 2-1 heater terminal 48 is in contact with a 2-1 heater pad 156 of the ceramic element 120; and the 2-2 heater terminal 49 is in contact with a 2-2 heater pad 158 of the ceramic element 120 (see FIGS. 1, 2, 8 and 9).

Further, within the second insertion hole 45d, distal end portions of an auxiliary potential lead wire 164, a 2-1 heater lead wire 174, and a 2-2 heater lead wire 176 (to be described later) are disposed. Within the second insertion hole 45d, the auxiliary potential terminal 47 and the auxiliary potential lead wire 164 are connected to each other; the 2-1 heater terminal 48 and the 2-1 heater lead wire 174 are connected to each other; and the 2-2 heater terminal 49 and the 2-2 heater lead wire 176 are connected to each other.

The inner-tube metal connection member 50 is a stainless steel member and is fitted onto a proximal end portion 40k of the inner tube 40 while surrounding a proximal end portion of the second separator 45, and a distal end portion 50s of the inner-tube metal connection member 50 is laser-welded to the proximal end portion 40k of the inner tube 40. The four electric wires 161, 163, 173, and 175 are passed through the inner-tube metal connection member 50. The electric wires 171 and 177 are not passed through the inner-tube metal connection member 50. Of these electric wires, the inner-side outer conductors 161g1 and 163g1 of the electric wires 161 and 163, which are triple coaxial cables as will be described later, are connected to the inner-tube metal connection member 50.

The gas introduction pipe 25 is composed of the inner protector 60 and the outer protector 65. The inner protector 60 is a closed-bottomed cylindrical member formed of stainless steel, and the outer protector 65 is a cylindrical member formed of stainless steel. The outer protector 65 is disposed around the inner protector 60 with respect to the radial direction. The inner protector 60 and the outer protector 65 are fitted onto a distal end portion 30s of the metallic shell 30 and are laser-welded to the distal end portion 30s. The gas introduction pipe 25 surrounds, from the radially outward side, a distal end portion of the ceramic element 120 projecting from the metallic shell 30 toward the distal end side GS to thereby protect the ceramic element 120 from water droplets and foreign substances as well as introduce the exhaust gas EG to a space around the ceramic element 120.

The outer protector 65 has the plurality of rectangular gas introduction openings 65c formed in a distal end portion thereof for introducing the exhaust gas EG, which flows through the exhaust pipe EP, into the interior of the outer protector 65. Also, the inner protector 60 has a plurality of circular first inner introduction openings 60c formed in a proximal end portion thereof for introducing, into the interior thereof, the introduced gas EGI introduced into the outer protector 65. The introduced gas EGI is a portion of the exhaust gas EG flowing through the exhaust pipe EP. The inner protector 60 also has a plurality of triangular second inner introduction openings 60d formed in a distal end portion thereof. Further, the inner protector 60 has the circular gas discharge opening 60e formed in a bottom wall thereof for discharging the introduced gas EGI into the exhaust pipe EP. A distal end portion 60s of the inner protector 60, including the gas discharge opening 60e, projects toward the distal end side GS from a distal end opening 65s of the outer protector 65.

Here, there will be described the introduction and discharge of the exhaust gas EG into and from the interiors of the inner protector 60 and the outer protector 65 when the fine particle sensor 10 is used (see FIG. 10). Notably, in FIG. 10, the exhaust gas EG flows within the exhaust pipe EP from the left-hand side toward the right-hand side. When the exhaust gas EG passes through a region around the outer protector 65 and the inner protector 60, its flow velocity increases on the outer side of the gas discharge opening 60e of the inner protector 60, and a negative pressure is produced near the gas discharge opening 60e due to the so-called Venturi effect.

By this negative pressure, the introduced gas EGI introduced into the inner protector 60 is discharged to the exhaust pipe EP through the gas discharge opening 60e. Simultaneously, the exhaust gas EG around the gas introduction openings 65c of the outer protector 65 is introduced into the interior of the outer protector 65 through the gas introduction openings 65c, and is further introduced into the interior of the inner protector 60 through the first inner introduction openings 60c of the inner protector 60. The introduced gas EGI within the inner protector 60 is discharged through the gas discharge opening 60e. Thus, as indicated by the broken line arrow, a flow of the introduced gas EGI from the first inner introduction openings 60c on the proximal end side GK toward the gas discharge opening 60e on the distal end side GS is produced within the inner protector 60.

Next, the outer metallic member 70 will be described. As shown in FIGS. 1 and 3, the outer metallic member 70, which has a cylindrical shape and is formed of a metallic material, surrounds the radially outer circumference of the inner metallic member 20 while being separated from the inner metallic member 20, and is attached to the exhaust pipe EP maintained at the ground potential PVE, whereby the outer metallic member 70 is maintained at the ground potential PVE. The outer metallic member 70 is composed of a mounting metallic member 80 and an outer tube 90.

The mounting metallic member 80 is a cylindrical stainless steel member extending in the longitudinal direction GH. The mounting metallic member 80 is disposed to surround the radially outer circumference of the metallic shell 30 of the inner metallic member 20 and a distal end portion of the inner tube 40 of the inner metallic member 20 in such a manner as to be separated from them. The mounting metallic member 80 has a flange portion 81 which projects toward the radially outward side so as to form a hexagonal outer shape. The mounting metallic member 80 has an internal stepped portion 83. The mounting metallic member 80 also has a male screw (not shown) used for fixation to the exhaust pipe EP and formed on the outer circumference of its distal end portion 80s located on the distal end side GS of the flange portion 81. By means of the male screw of the distal end portion 80s, the fine particle sensor 10 is attached to an attachment boss BO which is formed of metal and is separately fixed to the exhaust pipe EP, whereby the fine particle sensor 10 is fixed to the exhaust pipe EP via the attachment boss BO (see FIG. 1).

The insulating spacer 100 (to be described later) is disposed between the outer metallic member 70 and the inner metallic member 20; specifically, between the mounting metallic member 80 and the metallic shell 30. A crimp portion 80kk, located furthest toward the proximal end side GK, of the mounting metallic member 80 is crimped toward the radially inward side GDI, thereby pressing an annular projecting portion 103 of the insulating spacer 100 toward the distal end side GS via a line packing 87, a pressing sleeve 110, and a powder charged body 115. As a result, the annular projecting portion 103 of the insulating spacer 100 is brought into contact with the stepped portion 83 of the mounting metallic member 80, whereby the insulating spacer 100 is fixed to the mounting metallic member 80.

The outer tube 90 is a tubular stainless steel member extending in the longitudinal direction GH. A distal end portion 90s of the outer tube 90 is fitted onto a proximal end portion 80k of the mounting metallic member 80 and is laser-welded to the proximal end portion 80k. An outer-tube metal connection member 95 is disposed in the interior of a small diameter portion 91 of the outer tube 90 located on the proximal end side GK; further, a grommet 97 formed of fluororubber is disposed on the proximal end side GK of the outer-tube metal connection member 95 in the interior of the small diameter portion 91. The six electric wires 161, 163, 171, 173, 175, and 177 (to be described later) are passed through the outer-tube metal connection member 95 and the grommet 97. Of these electric wires, outer-side outer conductors 161g2 and 163g2 of the electric wires 161 and 163, which are triple coaxial cables as will be described later, are connected to the outer-tube metal connection member 95. The outer-tube metal connection member 95 is crimped together with the small diameter portion 91 of the outer tube 90 so that the diameter of the outer-tube metal connection member 95 decreases toward the radially inward side; thus, the outer-tube metal connection member 95 and the grommet 97 are fixed within the small diameter portion 91 of the outer tube 90.

Next, the insulating spacer 100 will be described. As shown in FIGS. 5 and 6, the insulating spacer 100 is a cylindrical member which extends in the longitudinal direction GH and is mainly formed of alumina. As described above, the insulating spacer 100 is interposed between the inner metallic member 20 and the outer metallic member 70 so as to electrically insulate them from each other. Specifically, the insulating spacer 100 is disposed between the metallic shell 30 and a distal end portion of the inner tube 40, and the mounting metallic member 80 and a distal end portion of the outer tube 90 (see FIG. 1), wherein the metallic shell 30 and the inner tube 40 are portions of the inner metallic member 20, and the mounting metallic member 80 and the outer tube 90 are portions of the outer metallic member 70.

The insulating spacer 100 is composed of an approximately cylindrical tubular portion 100t and the annular projecting portion 103 annularly projecting from the tubular portion 100t toward a radially outer side GDO (see FIGS. 5 and 6). A portion of the tubular portion 100t of the insulating spacer 100 on the distal end side GS is a gas contact portion 100s (see FIGS. 1 and 2). This gas contact portion 100s has gas contact surfaces 100m which are exposed to the interior of the exhaust pipe EP (face the interior of the exhaust pipe EP) and come into contact with the exhaust gas EG in a state in which the fine particle sensor 10 is attached to the exhaust pipe EP (see FIGS. 1 and 6).

The tubular portion 100t includes a cylindrical spacer body 101 formed of alumina, and a laminar heater portion 102 wound around a cylindrical outer circumferential surface 101g of the spacer body 101. The laminar heater portion 102 is wound around the outer circumferential surface 101g of the spacer body 101 in such a manner that its opposite end portions in the circumferential direction do not overlap each other and the laminar heater portion 102 forms a single-wall cylinder (which has a C-like cross section). The spacer body 101 has a thick wall portion 101f formed at a position on the distal end side GS in the longitudinal direction GH along the axial line AX, and a distal end thin wall portion 101s located on the distal end side GS of the thick wall portion 101f.

The annular projecting portion 103 is gas-tightly fitted onto the laminar heater portion 102 and projects toward the radially outer side GDO of the insulating spacer 100.

As shown in FIG. 7, the laminar heater portion 102 is composed of a laminar spacer heater 105, a base insulating layer 108 located on the inner side of the spacer heater 105 and formed of alumina, and a cover insulating layer 109 located on the outer side of the spacer heater 105 and formed of alumina. The spacer heater 105 (see FIG. 7) is composed of a laminar heat generation resistor 106 formed of tungsten and heater lead portions 107. The heater lead portions 107 are composed of lead main bodies 107p respectively extending from the opposite ends of the heat generation resistor 106, terminal pads 107m exposed to the surface of the laminar heater portion 102, and via conductors 107V which extend through the cover insulating layer 109 and establish electrical communication between the lead main bodies 107p and the terminal pads 107m.

Of these, the heat generation resistor 106 extends in the circumferential direction CD of the insulating spacer 100 while meandering (zigzagging). As shown in FIG. 5, as a result of the laminar heater portion 102 being wound around the spacer main body 101, one end portion 106p of the heat generation resistor 106 located on one side CD1 and the other end portion 106q of the heat generation resistor 106 located on the other side CD2 are disposed to face each other and to be close to each other in the circumferential direction CD. The heat generation resistor 106 is disposed inside the gas contact portion 100s of the insulating spacer 100 (see FIGS. 5 and 6). Therefore, when the heat generation resistor 106 of the spacer heater 105 is caused to generate heat, the heat of the heat generation resistor 106 is transferred to the gas contact portion 100s, whereby the gas contact surfaces 100m of the gas contact portion 100s can be heated appropriately.

Notably, the heat generation resistor 106 of the spacer heater 105 is covered with the cover insulating layer 109, whereby the heat generation resistor 106 is embedded in the insulating spacer 100. This configuration prevents the exhaust gas EG from coming into contact with the heat generation resistor 106. Therefore, it is possible to prevent occurrence of a state in which energization of the spacer heater 105 cannot be preformed appropriately or the heat generation resistor 106 deteriorates, which state would otherwise occur when foreign substances (soot, water droplets, etc.) contained in the exhaust gas EG adhere to the heat generation resistor 106. Accordingly, even in the case where the fine particle sensor 10 is used for a long period of time, the heating performance of the spacer heater 105 can be maintained satisfactorily.

The annular projecting portion 103 is composed of a ceramic ring 103c and a glass seal 103g. The ceramic ring 103c is formed of alumina, has an annular shape, and is fitted onto the tubular portion 100t (specifically, the laminar heater portion 102 provided on the outer circumference of the spacer body 101). The glass seal 103g is formed of glass and gas-tightly fixes the ceramic ring 103c to the laminar heater portion 102. As shown in FIG. 1, as a result of crimping of the crimp portion 80kk of the mounting metallic member 80, the annular projecting portion 103 is pressed toward the distal end side GS via the line packing 87, the pressing sleeve 110, and the powder charged body 115, so that the annular projecting portion 103 is brought into pressure-contact with the stepped portion 83 of the mounting metallic member 80. As described above, since the annular projecting portion 103 is provided on the insulating spacer 100, the insulating spacer 100 can be easily fixed to the metallic attachment member 80 in a gas-tight condition.

The insulating spacer 100 is formed as follows. Specifically, a green laminar heater portion 102 including the heat generation resistor 106 and the lead main bodies 107p formed through pattern printing is wound around the outer circumference of the calcined spacer body 101 and is fired. Subsequently, the ceramic ring 103c is fitted onto the laminar heater portion 102 and is gas-tightly fixed thereto by using glass, so that the glass seal 103g is provided. As a result, the insulating spacer 100 is formed.

As shown in FIG. 2, the two heater lead portions 107 of the laminar heater portion 102 of the insulating spacer 100 are connected, via connection terminals 181 and 182, heater lead wires 172 and 178 which are core wires of the single-core electric wires 171 and 177. Specifically, distal end portions of the heater lead wires 172 and 178 of the electric wires 171 and 177 are held by the connection terminals 181 and 182 brazed to the terminal pads 107m and 107m, so that the heater lead wires 172 and 178 electrically communicate with the terminal pads 107m and 107m.

Next, the ceramic element 120 will be described. The ceramic element 120 has a plate-shaped insulating ceramic substrate 121 formed of alumina and extending in the longitudinal direction GH (see FIGS. 8 and 9). A discharge electrode member 130, an auxiliary electrode member 140, and an element heater 150 are embedded in the ceramic substrate 121, and are sintered together with the ceramic substrate 121.

Specifically, the ceramic substrate 121 is a ceramic laminate in which three ceramic layers 122, 123, and 124 formed of alumina originating from an alumina green sheet are layered together, and two insulating cover layers 125 and 126 of alumina are formed between these layers by means of printing. The ceramic layer 122 and the insulating cover layer 125 are shorter than the ceramic layers 123 and 124 and the insulating cover layer 126 as measured on the distal end side GS and the proximal end side GK in the longitudinal direction GH. The discharge electrode member 130 is disposed between the insulating cover layer 125 and the ceramic layer 123. Also, the auxiliary electrode member 140 is disposed between the ceramic layer 123 and the insulating cover layer 126, and the element heater 150 is disposed between the insulating cover layer 126 and the ceramic layer 124.

The discharge electrode member 130 extends in the longitudinal direction GH and is composed of a needle-shaped electrode portion 131 located at the distal end side GS, a discharge potential pad 135 located at the proximal end side GK, and a lead portion 133 extending therebetween. The needle-shaped electrode portion 131 is formed of a platinum wire. Meanwhile, the lead portion 133 and the discharge potential pad 135 are formed of tungsten by means of pattern printing. Of the discharge electrode member 130, a proximal end portion 131k of the needle-shaped electrode portion 131 and the entire lead portion 133 are embedded in the ceramic substrate 121. Meanwhile, a distal end portion 131s of the needle-shaped electrode portion 131 projects from the ceramic substrate 121 on the distal end side GS of the ceramic layer 122 of the ceramic substrate 121. Also, the discharge potential pad 135 is exposed on the proximal end side GK of the ceramic layer 122 of the ceramic substrate 121. As mentioned above, the discharge potential terminal 46 is in contact with the discharge potential pad 135 within the insertion hole 44c of the first separator 44.

The auxiliary electrode member 140 extends in the longitudinal direction GH, is formed by means of pattern printing, and is entirely embedded in the ceramic substrate 121. The auxiliary electrode member 140 is composed of a rectangular auxiliary electrode portion 141 located at the distal end side GS and a lead portion 143 connected to the auxiliary electrode portion 141 and extending toward the proximal end side GK. A proximal end portion 143k of the lead portion 143 is connected to a conductor pattern 145 formed on one main surface 124a of the ceramic layer 124 through a through hole 126c of the insulating cover layer 126. Further, the conductor pattern 145 is connected to the auxiliary potential pad 147 formed on the other main surface 124b of the ceramic layer 124 via a through hole conductor 146 formed in the ceramic layer 124 in such a manner as to extend therethrough. As mentioned above, the auxiliary potential terminal 47 is in contact with the auxiliary potential pad 147 within the second insertion hole 45d of the second separator 45.

The element heater 150 is formed by means of pattern printing and is entirely embedded in the ceramic substrate 121. The element heater 150 is composed of a heat generation resistor 151 located at the distal end side GS for heating the ceramic element 120, and paired heater lead portions 152 and 153 connected to the opposite ends of the heat generation resistor 151 and extending toward the proximal end side GK. A proximal end portion 152k of one heater lead portion 152 is connected to the 2-1 heater pad 156 formed on the other main surface 124b of the ceramic layer 124 via a through hole conductor 155 formed in the ceramic layer 124 in such a manner as to extend therethrough. As mentioned above, the 2-1 heater terminal 48 is in contact with the 2-1 heater pad 156 within the second insertion hole 45d of the second separator 45. Also, a proximal end portion 153k of the other heater lead portion 153 is in contact with the 2-2 heater pad 158 formed on the other main surface 124b of the ceramic layer 124 via a through hole conductor 157 formed in the ceramic layer 124 in such a manner as to extend therethrough. As mentioned above, the 2-2 heater terminal 49 is in contact with the 2-2 heater pad 158 within the second insertion hole 45d of the second separator 45.

Next, the electric wires 161, 163, 171, 173, 175, and 177 will be described (see FIGS. 1 and 3). Of these six electric wires, the two electric wires 161 and 163 are triple coaxial cables (triaxial cables), and the remaining four electric wires 171, 173, 175, and 177 are small-diameter single-core insulated electric wires.

Of these electric wires, the electric wire 161 has the discharge potential lead wire 162 as a core wire (center conductor). As mentioned above, the discharge potential lead wire 162 is connected to the discharge potential terminal 46 within the first insertion hole 45c of the second separator 45. Also, the electric wire 163 has the auxiliary potential lead wire 164 as a core wire (center conductor). The auxiliary potential lead wire 164 is connected to the auxiliary potential terminal 47 within the second insertion hole 45d of the second separator 45. Of the coaxial double outer conductors of the electric wires 161 and 163, the inner-side outer conductors 161g1 and 163g1 located on the inner side are connected to the inner-tube metal connection member 50 of the inner metallic member 20 to thereby be maintained at the first potential PV1. Meanwhile, the outer-side outer conductors 161gand 163g2 located on the outer side are connected to the outer-tube metal connection member 95 electrically communicating with the outer metallic member 70 to thereby be maintained at the ground potential PVE.

Also, the electric wire 171 has the heater lead wire 172 as a core wire. Also, the electric wire 177 has the heater lead wire 178 as a core wire. As described above, the heater lead wires 172 and 178 are connected, through the connection terminals 181 and 182, to the two heater lead portions 107 of the laminar heater portion 102 of the insulating spacer 100 (specifically, to the terminal pads 107m). Also, the electric wire 173 has the 2-1 heater lead wire 174 as a core wire. The 2-1 heater lead wire 174 is connected to the 2-1 heater terminal 48 within the second insertion hole 45d of the second separator 45. Also, the electric wire 175 has the 2-2 heater lead wire 176 as a core wire. The 2-2 heater lead wire 176 is connected to the 2-2 heater terminal 49 within the second insertion hole 45d of the second separator 45.

Next, the circuit section 200 will be described. As shown in FIG. 4, the circuit section 200 is connected to the electric wires 161, 163, 171, 173, 175, and 177 of the fine particle sensor 10. The circuit section 200 drives the fine particle sensor 10 and detects a signal current Is (to be described later). The circuit section 200 has an ion source power supply circuit 210, an auxiliary electrode power supply circuit 240, and a measurement control circuit 220.

Of these circuits, the ion source power supply circuit 210 has a first output terminal 211 maintained at the first potential PV1 and a second output terminal 212 maintained at a second potential PV2. The second potential PV2 is a positive high potential in relation to the first potential PV1.

The auxiliary electrode power supply circuit 240 has an auxiliary first output terminal 241 maintained at the first potential PV1 and an auxiliary second output terminal 242 maintained at an auxiliary electrode potential PV3. The auxiliary electrode potential PV3 is a positive high DC potential in relation to the first potential PV1, but is lower than a peak potential of the second potential PV2.

The measurement control circuit 220 has a signal current detection circuit 230, a first heater energization circuit 223, a second heater energization circuit 225, and a microprocessor 221. Of these, the signal current detection circuit 230 has a first input terminal 231 maintained at the first potential PV1 and a second input terminal 232. The signal current detection circuit 230 detects the signal current Is flowing between the first input terminal 231 and the second input terminal 232. Notably, the first potential PV1 is higher than the ground potential PVE by an offset voltage V_{offset} (specifically, 0.5 V). Accordingly, the second input terminal 232 has a potential which is higher than the ground potential PVE by the offset voltage V_{offset} (specifically, 0.5 V).

Also, the first heater energization circuit 223 has a 1-1 heater energization terminal 223a which is connected to the heater lead wire 172 of the electric wire 171, and a 1-2 heater energization terminal 223b which is maintained at the ground potential PVE. The first heater energization circuit 223 energizes the spacer heater 105 of the insulating spacer 100 by PWM control, thereby causing the heat generation resistor 106 of the spacer heater 105 to generate heat.

Also, the second heater energization circuit 225 has a 2-1 heater energization terminal 225a which is connected to the 2-1 heater lead wire 174 of the electric wire 173, and a 2-2 heater energization terminal 225b which is connected to the 2-2 heater lead wire 176 of the electric wire 175 to thereby be maintained at the ground potential PVE. The second heater energization circuit 225 energizes the element heater 150 of the ceramic element 120 by PWM control, thereby causing the heat generation resistor 151 of the element heater 150 to generate heat.

In the circuit section 200, the ion source power supply circuit 210 and the auxiliary electrode power supply circuit 240 are surrounded by an inner circuit case 250 maintained at the first potential PV1. Also, the inner circuit case 250 accommodates and surrounds a secondary iron core 271b of an insulated transformer 270 and electrically communicates with the inner-side outer conductors 161g1 and 163g1 of the electric wires 161 and 163 maintained at the first potential PV1. The insulated transformer 270 is configured such that its iron core 271 is divided into a primary iron core 271a having a primary coil 272 wound thereon and the secondary iron core 271b having a power-supply-circuit-side coil 273 and an auxiliary-electrode-power-supply-side coil 274 wound thereon. The primary iron core 271a electrically communicates with the ground potential PVE, and the secondary iron core 271b electrically communicates with the first potential PV1.

Further, the ion source power supply circuit 210, the auxiliary electrode power supply circuit 240, the inner circuit case 250, and the measurement control circuit 220 are surrounded by an outer circuit case 260 maintained at the ground potential PVE. Also, the outer circuit case 260 accommodates and surrounds the primary iron core 271a of the insulated transformer 270 and electrically communicates with the outer-side outer conductors 161g2 and 163g2 of the electric wires 161 and 163 maintained at the ground potential PVE.

The measurement control circuit 220 has a built-in regulator power supply PS. The regulator power supply PS is driven by an external battery BT through a power supply wiring BC. A portion of electric power input to the measurement control circuit 220 through the regulator power supply PS is distributed to the ion source power supply circuit 210 and the auxiliary electrode power supply circuit 240 via the insulated transformer 270. Also, the measurement control circuit 220 has the microprocessor 221 and can communicate, through a communication line CC, with a control unit ECU for controlling the internal combustion engine. Thus, the measurement control circuit 220 can send signals indicative of results of measurement (the magnitude of the signal current Is) by the aforementioned signal current detection circuit 230, etc., to the control unit ECU.

Next, the electrical function and operation of the fine particle detection system 1 will be described. The discharge electrode member 130 of the ceramic element 120 is connected to and electrically communicates with the second output terminal 212 of the ion source power supply circuit 210 through the discharge potential lead wire 162 of the electric wire 161 to thereby be maintained at the second potential PV2 (see FIGS. 4, 8, and 9). Meanwhile, the auxiliary electrode member 140 of the ceramic element 120 is connected to and electrically communicates with the auxiliary second output terminal 242 of the auxiliary electrode power supply circuit 240 through the auxiliary potential lead wire 164 of the electric wire 163 to thereby be maintained at the auxiliary electrode potential PV3. Further, the inner metallic member 20 is connected to and electrically communicates with the inner circuit case 250, etc., through the inner-side outer conductors 161g1 and 163g1 of the electric wires 161 and 163 to thereby be maintained at the first potential PV1 (see FIGS. 1, 3, and 4). Additionally, the outer metallic member 70 is connected to and electrically communicates with the outer circuit case 260, etc., through the outer-side outer conductors 161g2 and 163g2 of the electric wires 161 and 163 to thereby be maintained at the ground potential PVE.

The second potential PV2 of a positive high voltage (e.g., 1 kV to 2 kV) is applied from the ion source power supply circuit 210 of the circuit section 200 to the needle-shaped electrode portion 131 of the discharge electrode member 130 through the discharge potential lead wire 162 of the electric wire 161, the discharge potential terminal 46, and the discharge potential pad 135. As a result, gaseous discharge; specifically, corona discharge, occurs between the needle-shaped end portion 131ss of the needle-shaped electrode portion 131 and the inner protector 60 maintained at the first potential PV1, whereby ions CP are generated around the needle-shaped end portion 131ss (see FIG. 10).

As described above, by the action of the gas introduction pipe 25, the exhaust gas EG is introduced into the interior of the inner protector 60, and a flow of the introduced gas EGI from the proximal end side GK toward the distal end side GS is produced near the ceramic element 120. Therefore, the generated ions CP adhere to fine particles S contained in the introduced gas EGI. As a result, the fine particles S become positively electrified fine particles SC, which flow toward the gas discharge opening 60e together with the introduced gas EGI, and are discharged into the exhaust pipe EP (see FIG. 10).

Meanwhile, a predetermined potential (e.g., a positive DC potential of 100 V to 200 V) is applied from the auxiliary electrode power supply circuit 240 of the circuit section 200 to the auxiliary electrode portion 141 of the auxiliary electrode member 140 through the auxiliary potential lead wire 164 of the electric wire 163, the auxiliary potential terminal 47, and the auxiliary potential pad 147 so that the auxiliary electrode portion 141 is maintained at the auxiliary electrode potential PV3. Thus, a repulsive force directed from the auxiliary electrode portion 141 toward the inner protector 60 (collection electrode) located on the radially outward side acts on floating ions CPF, which are some of the generated ions CP and have not adhered to the fine particles S. As a result, the floating ions CPF are caused to adhere to various portions of the collection electrode (inner protector 60), whereby collection of the floating ions CPF by the collection electrode is assisted (see FIG. 10). Thus, the floating ions CPF can be collected reliably, and the floating ions CPF are prevented from being discharged through the gas discharge opening 60e.

In the fine particle detection system 1, the signal current detection circuit 230 detects the signal current Is which is a sensor signal corresponding to the amount of charge of discharged ions CPH adhering to the electrified fine particles SC which are discharged through the gas discharge opening 60e. As a result, the amount (concentration) of the fine particles S contained in the exhaust gas EG can be detected. As described above, in the present Embodiment 1, the ions CP generated by means of gaseous discharge are caused to adhere to the fine particles S contained in the exhaust gas EG introduced into the gas introduction pipe 25 to thereby produce the electrified fine particles SC, and the amount of the fine particles S in the exhaust gas EG is detected through use of the signal current Is flowing between the first potential PV1 and the ground potential PVE in accordance with the amount of the electrified fine particles SC.

Further, the fine particle sensor 10 has the element heater 150 in the ceramic element 120. The 2-1 heater pad 156 of the element heater 150 electrically communicates with the 2-1 heater energization terminal 225a of the second heater energization circuit 225 of the circuit section 200 through the 2-1 heater terminal 48 and the 2-1 heater lead wire 174 of the electric wire 173. Also, the 2-2 heater pad 158 of the element heater 150 electrically communicates with the 2-2 heater energization terminal 225b of the second heater energization circuit 225 through the 2-2 heater terminal 49 and the 2-2 heater lead wire 176 of the electric wire 175.

Therefore, when a predetermined heater energization voltage from the second heater energization circuit 225 is applied between the 2-1 heater pad 156 and the 2-2 heater pad 158, the heat generation resistor 151 of the element heater 150 generates heat upon energization. As a result, the ceramic element 120 is heated, whereby foreign substances (water droplets, soot, etc.) adhering to the ceramic element 120 can be removed. Therefore, the insulation properties of the ceramic element 120 can be recovered or maintained.

Incidentally, the gas contact surfaces 100m of the insulating spacer 100 of the present Embodiment 1 come into contact with the exhaust gas EG flowing through the exhaust pipe EP. Therefore, foreign substances (water, soot, etc.) contained in the exhaust gas EG may adhere to the gas contact surfaces 100m of the insulating spacer 100. When such foreign substances adhere to the gas contact surfaces 100m, the insulation properties of the insulating spacer 100 deteriorate, and the insulation between the inner metallic member 20 maintained at the first potential PV1 and the outer metallic member 70 maintained at the ground potential PVE deteriorates. In such a case, the fine particle sensor 10 may fail to appropriately detect the amount of the fine particles S contained in the exhaust gas EG.

In view of this, the fine particle sensor 10 of the present Embodiment 1 has the spacer heater 105 in the insulating spacer 100. The one terminal pad 107m of the spacer heater 105 is connected to the 1-1 heater energization terminal 223a of the first heater energization circuit 223 through the connection terminal 181 and the heater lead wire 172 of the electric wire 171. Also, the other terminal pad 107m of the spacer heater 105 is connected to the 1-2 heater energization terminal 223b of the first heater energization circuit 223 through the connection terminal 182 and the heater lead wire 178 of the electric wire 177. This connection allows the first heater energization circuit 223 to supply electricity to the spacer heater 105 (the heat generation resistor 106).

Therefore, when electricity is supplied from the first heater energization circuit 223 to the spacer heater 105, the heat generation resistor 106 of the spacer heater 105 generates heat. As a result, the gas contact portion 100s (the gas contact surfaces 100m) of the insulating spacer 100 is heated, whereby foreign substances (water, soot, etc.) adhering to the gas contact surfaces 100m of the gas contact portion 100s can be removed. As a result, the insulation properties of the insulating spacer 100 (the insulation properties of the gas contact surfaces 100m) having deteriorated as a result of adhesion of foreign substances (water, soot, etc.) to the gas contact surfaces 100m can be recovered.

A method of recovering the insulation between the inner metallic member 20 and the outer metallic member 70 in the present Embodiment 1 will now be described in detail.

In the fine particle detection system 1 of the present Embodiment 1, after the operation of the engine is started, a test is performed so as to determine whether or not the degree of insulation between the inner metallic member 20 (the first potential PV1) and the outer metallic member 70 (the ground potential PVE) falls within an allowable range. Specifically, as described above, the offset voltage V_{offset} (specifically, 0.5 V) is applied between the inner metallic member 20 (the first potential PV1) and the outer metallic member 70 (the ground potential PVE). Therefore, leak current Im flows between the inner metallic member 20 and the outer metallic member 70 in accordance with the degree of insulation between the inner metallic member 20 and the outer metallic member 70. This leak current Im is detected by the signal current detection circuit 230. The microprocessor 221 determines whether or not the magnitude of the leak current Im detected by the signal current detection circuit 230 falls within the allowable range (specifically, is equal to or less than a reference value Ims (threshold value) set in advance). In the present Embodiment 1, the “degree of insulation” is represented by the magnitude of the leak current Im.

Notably, the allowable range for the degree of insulation between the inner metallic member 20 and the outer metallic member 70; specifically, the reference value Ims (threshold value) for the leak current Im is set on the basis of the range of the degree of insulation within which the fine particle detection system 1 can appropriately detects the amount of the fine particles S contained in the exhaust gas EG. In the case where a foreign substance (water, soot, etc.) has adhered to the gas contact surfaces 100m of the gas contact portion 100s of the insulating spacer 100, it is possible to determine that the degree of insulation between the inner metallic member 20 and the outer metallic member 70 falls outside the allowable range; specifically, the leak current Im is greater than the reference value Ims (threshold value).

In the case where the fine particle detection system 1 of the present Embodiment 1, in the case where it is determined that the degree of insulation between the inner metallic member 20 and the outer metallic member 70 falls outside the allowable range (specifically, the leak current Im is greater than the reference value Ims), heater energization is performed; namely, the spacer heater 105 is energized by the first heater energization circuit 223 so as to cause the heat generation resistor 106 to generate heat, to thereby heat the gas contact portion 100s (the gas contact surfaces 100m) of the insulating spacer 100.

More specifically, in the case where it is determined, after the operation of the engine is started, that the leak current Im is greater than the reference value Ims, the heater energization is performed so as to raise the temperature of the spacer heater 105 to a temperature at which the foreign substance (water, soot, or the like) adhering to the gas contact surfaces 100m is removed (specifically, a temperature within the range of 500° C. to 600° C.). This heating procedure removes the foreign substance (water, soot, or the like) adhering to the gas contact surfaces 100m of the insulating spacer 100 and recovers the insulation properties of the insulating spacer 100 (the insulation properties of the gas contact surfaces 100m) having deteriorated as a result of adhesion of the foreign substance to the gas contact surfaces 100m.

Incidentally, when the above-described heater energization (specifically, energization for raising the temperature of the spacer heater 105 to a temperature within the range of 500° C. to 600° C.) is performed, since the temperature of the insulating spacer 100 elevates, the volume resistivity (volume specific resistance) of the insulating spacer 100 decreases. Therefore, immediately after performance of the above-described heater energization, the insulating spacer 100 may fail to appropriately provide electrical insulation between the inner metallic member 20 and the outer metallic member 70. In such a case, if the fine particle sensor 10 is driven, after performance of the second heater energization, so as to detect the amount of the fine particles S contained in the exhaust gas EG, there arises a possibility that the amount of the fine particles S contained in the exhaust gas EG cannot be detected appropriately.

In view of this, in the fine particle detection system 1 of the present Embodiment 1, in the case where the fine particle sensor 10 is driven after performance of the above-described heater energization, the fine particle sensor 10 is driven upon elapse of a certain cooling time tc after the end of the heater energization. As a result of elapse of the certain cooling time tc after the end of the heater energization, the temperature of the insulating spacer 100 drops, whereby the volume resistivity (volume specific resistance) of the insulating spacer 100 can be recovered. As a result, the insulating spacer 100 can appropriately provide electrical insulation between the inner metallic member 20 and the outer metallic member 70. By driving the fine particle sensor 10 after that, the amount of the fine particles S contained in the exhaust gas EG can be detected appropriately.

Meanwhile, in the case where it is determined, without performance of the above-described heater energization, that the degree of insulation between the inner metallic member 20 and the outer metallic member 70 falls within the allowable range (specifically, it is determined that the leak current Im is equal to or less than the reference value Ims), the fine particle sensor 10 is driven after the determination without waiting for elapse of the cooling time tc. As a result, the amount of the fine particles S contained in the exhaust gas EG can be detected appropriately.

Notably, in the present Embodiment 1, the “certain cooling time tc” is set to a time (for example, 10 minutes) within which the temperature of the insulating spacer 100 having elevated due to the heater energization is expected to drop to the temperature before performance of the heater energization.

Also, in the fine particle detection system 1 of the present Embodiment 1, the signal current Is is very small. As described above, in the case where it is determined that the leak current Im is equal to or less than the reference value Ims, the detection of the amount of the fine particles S is performed. Meanwhile, in the case where it is determined that the leak current Im is greater than the reference value Ims, the foreign substance adhering to the gas contact surfaces 100m is removed by the heater energization, and upon elapse of the certain cooling time tc after the end of the heater energization, the detection of the amount of the fine particles S is performed. As a result, in the fine particle detection system 1, the very small signal current Is can be detected appropriately without being affected by the leak current Im, whereby the amount of the fine particles S contained in the exhaust gas EG can be detected appropriately.

Next, the flow of fine particle detection according to the present Embodiment 1 will be described. FIG. 11 is a flowchart showing the flow of fine particle detection according to the present Embodiment 1.

When the operation of the engine is started as a result of a key switch (not shown) of the engine being turned on, in step S1, in response to an instruction from the microprocessor 221, the signal current detection circuit 230 detects the leak current Im flowing between the first input terminal 231 and the second input terminal 232; namely, between the inner metallic member 20 (the first potential PV1) and the outer metallic member 70 (the ground potential PVE). Subsequently, in step S2, the microprocessor 221 determines whether or not the magnitude of the leak current Im detected by the signal current detection circuit 230 falls within the allowable range (specifically, is equal to or less than the reference value Ims set in advance).

In the case where the microprocessor 221 determines that the leak current Im is equal to or less than the reference value Ims (YES), the microprocessor 221 proceeds to step S3 so as to drive the fine particle sensor 10. Specifically, as described above, the microprocessor 221 performs processes, such as generation of ions CP by corona discharge, by activating the ion source power supply circuit 210 and the auxiliary electrode power supply circuit 240.

Subsequently, the microprocessor 221 proceeds to step S4 so as to detect the amount of the fine particles S contained in the exhaust gas EG. Specifically, as described above, the microprocessor 221 detects a signal (signal current Is) corresponding to the amount of charge of the discharged ions CPH by using the signal current detection circuit 230. As a result, the amount (concentration) of the fine particles S contained in the exhaust gas EG can be detected.

Meanwhile, in the case where the microprocessor 221 determines in step S2 that the leak current Im is greater than the reference value Ims (NO), the microprocessor 221 proceeds to step S5 so as to start the heater energization. Specifically, in response to an instruction from the microprocessor 221, the first heater energization circuit 223 supplies electricity to the spacer heater 105 through PWM control, to thereby raise the temperature of the spacer heater 105 to a temperature at which the foreign substance (water, soot, or the like) adhering to the gas contact surfaces 100m is removed (specifically, a temperature within the range of 500° C. to 600° C.)

After that, in step S6, the microprocessor 221 determines whether or not a predetermined time has elapsed after the start of the supply of electricity from the first heater energization circuit 223 to the spacer heater 105 (for example, the microprocessor 221 determines whether or not the period of time during which electricity is supplied from the first heater energization circuit 223 to the spacer heater 105 has reached a certain energization time set in advance). Notably, the predetermined time (certain energization time) is preferably set to, for example, a time which is necessary and sufficient for removal of the foreign substance adhering to the gas contact portion 100s.

In the case where the microprocessor 221 determines in step S6 that the predetermined time has elapsed after the start of the energization (YES), the microprocessor 221 proceeds to step S7. In step S7, in response to an instruction from the microprocessor 221, the first heater energization circuit 223 ends the supply of electricity to the spacer heater 105. In the case where the microprocessor 221 determines in step S6 that the predetermined time has not yet elapsed after the start of the supply of electricity to the spacer heater 105 (NO), the microprocessor 221 repeats the determination process of step S6 until the predetermined time elapses. As a result of performance of the processes of steps S5 to S7, the heater energization is executed, whereby the foreign substance adhering to the gas contact surfaces 100m of the insulating spacer 100 is removed.

When the microprocessor 221 ends the heater energization in step S7 by ending the supply of electricity to the spacer heater 105, the microprocessor 221 proceeds to step S8 so as to determine whether or not the certain cooling time tc has elapsed after the end of the heater energization (the supply of electricity to the spacer heater 105 by the first heater energization circuit 223). In the case where the microprocessor 221 determines that the cooling time tc has not yet elapsed (NO), the microprocessor 221 repeats the determination process of step S8 until the cooling time tc elapses. After that, in the case where the microprocessor 221 determines in step S8 that the cooling time tc has elapsed (YES), the microprocessor 221 proceeds to steps S3 and S4 and detects the amount of the fine particles S contained in the exhaust gas EG by performing the above-described process.

As described above, in the present Embodiment 1, after the operation of the engine (internal combustion engine) is started, a test is performed, prior to the start of driving of the fine particle sensor 10, so as to determine whether or not the degree of insulation between the inner metallic member 20 and the outer metallic member 70 falls within the allowable range (specifically, whether or not the leak current Im flowing between the inner metallic member 20 and the outer metallic member 70 is equal to or less than the reference value Ims).

In the case where it is determined that the degree of insulation falls within the allowable range (specifically, the leak current Im is equal to or less than the reference value Ims), the amount of the fine particles S is detected by driving the fine particle sensor 10. Also, in the case where it is determined that the degree of insulation falls outside the allowable range (specifically, the leak current Im is greater than the reference value Ims), the foreign substance adhering to the gas contact surfaces 100m is removed by the heater energization, and upon elapse of the certain cooling time tc after the heater energization, the amount of the fine particles S is detected. Accordingly, in the fine particle detection system 1 of the present Embodiment 1, after the operation of the engine (internal combustion engine) is started, the amount of the fine particles S contained in the exhaust gas EG discharged from the engine can be detected appropriately.

Notably, the microprocessor 221 performing the processes of steps S1 and S2 and the signal current detection circuit 230 correspond to the “insulation test means.” Also, the microprocessor 221 performing the process of step S3, the ion source power supply circuit 210, and the auxiliary electrode power supply circuit 240 correspond to the “sensor drive means.” Also, the microprocessor 221 performing the processes of steps S5 to S7 and the first heater energization circuit 223 correspond to the “heater energization means.”

### Embodiment 2

Next, Embodiment 2 of the present invention will be described. The present Embodiment 2 differs from Embodiment 1 in terms of the flow of fine particle detection (specifically, the heater energization and subsequent processes) (accordingly the control program input to the microprocessor 221) and is the same as Embodiment 1 in other points. Therefore, the point different from that of Embodiment 1 will be mainly described, and the points identical with those of Embodiment 1 will not be described or will be described in a simplified manner.

As in the case of the fine particle detection system 1 of Embodiment 1, in a fine particle detection system 301 of the present Embodiment 2 (see FIGS. 1 and 4), after the operation of the engine is started, the microprocessor 221 performs a test for determining whether or not the degree of insulation between the inner metallic member 20 (the first potential PV1) and the outer metallic member 70 (the ground potential PVE) falls within the allowable range. Specifically, the signal current detection circuit 230 measures the leak current Im (step T1 of FIG. 12), and the microprocessor 221 determines whether or not the magnitude of the measured leak current Im falls within the allowable range (specifically, is equal to or less than the reference value Ims (threshold value) set in advance (step T2 of FIG. 12).

In the case where the microprocessor 221 determines that the degree of insulation between the inner metallic member 20 and the outer metallic member 70 falls within the allowable range (specifically, the leak current Im is greater than the reference value Ims), the microprocessor 221 performs heater energization. Specifically, the microprocessor 221 causes the first heater energization circuit 223 to energize the spacer heater 105, to thereby cause the heat generation resistor 106 to generate heat. As a result, the gas contact portion 100s of the insulating spacer 100 is heated. However, in the present Embodiment 2, the microprocessor 221 performs heater energization (hereinafter referred to as “first heater energization”) different from the heater energization of Embodiment 1.

Specifically, in the present Embodiment 2, in the case where the microprocessor 221 determines that the leak current Im is greater than the reference value Ims after the operation of the engine has been started, the microprocessor 221 first performs the first heater energization for raising the temperature of the spacer heater 105 to a temperature at which water adhering to the gas contact surfaces 100m is removed (for example, a temperature within the range of 100° C. to 150° C.) (steps T5 to T7 of FIG. 12). By this heating, the water adhering to the gas contact surfaces 100m of the insulating spacer 100 can be removed (evaporated).

Incidentally, foreign substances (soot, oil, etc.) other than water which are contained in the exhaust gas EG may adhere to the gas contact surfaces 100m. If such foreign substances adhere to the gas contact surfaces 100m, the insulation properties of the gas contact surfaces 100m deteriorate. As a result, the insulation between the inner metallic member 20 and the outer metallic member 70 deteriorates, which may result in a failure to appropriately detect the amount of the fine particles S contained in the exhaust gas E. In some case, such foreign substances cannot be removed by the above-described first heater energization.

In view of this, in the fine particle detection system 301 of the present Embodiment 2, after the above-described first heater energization has ended (after the water adhering to the gas contact surfaces 100m of the insulating spacer 100 has been removed), the microprocessor 221 again performs a test for determining whether or not the degree of insulation between the inner metallic member 20 and the outer metallic member 70 falls within the allowable range (specifically, whether or not the leak current Im is equal to or less than the reference value Ims) (steps T8 to T9 of FIG. 12).

In the case where the microprocessor 221 determines that the degree of insulation falls outside the allowable range (specifically, the leak current Im is greater than the reference value Ims), the microprocessor 221 performs second heater energization which differs from the first heater energization in terms of the conditions of energization of the spacer heater 105 (steps T10 to T12 of FIG. 12). Specifically, the microprocessor 221 causes the first heater energization circuit 223 to energize the spacer heater 105, to thereby raise the temperature of the spacer heater 105 to a temperature for removal of the foreign substances (soot, oil, or the like) which have adhered to the contact surfaces 100m and cannot be removed by the first heater energization (a temperature higher than the temperature achieved by the first heater energization; for example, a temperate within the range of 500° C. to 600° C.)

The foreign substances (soot, oil, or the like) which have adhered to the contact surfaces 100m and cannot be removed by the above-described first heater energization can be removed (burnt out) by performing such second heater energization. As a result, the insulation properties of the insulating spacer 100 (the insulation properties of the gas contact surfaces 100m) having deteriorated as a result of adhesion of foreign substances, such as soot, to the gas contact surfaces 100m can be recovered.

Notably, in the present Embodiment 2, the switching between the first heater energization and the second heater energization is performed by changing the duty ratio of the PWM control performed by the first heater energization circuit 223. The magnitude of the effective voltage applied to the spacer heater 105 is changed by changing the duty ratio of the PWM control performed by the first heater energization circuit 223.

Incidentally, since the temperature of the insulating spacer 100 elevates as a result of performance of the above-described first heater energization, the volume resistivity (volume specific resistance) of the insulating spacer 100 decreases. However, in the present Embodiment 2, the dimensions of the insulating spacer 100 (specifically, the thickness of the insulating spacer 100 intervening between the inner metallic member 20 and the outer metallic member 70) are sufficiently large, so that even when the temperature of the insulating spacer 100 elevates as a result of performance of the first heater energization, the insulating spacer 100 can appropriately provide electrical insulation between the inner metallic member 20 and the outer metallic member 70 (in other words, the leak current Im becomes equal to or less than the reference value Ims) if the foreign substances are removed from the gas contact surfaces 100m of the insulating spacer 100.

Therefore, in the present Embodiment 2, even when the fine particle sensor 10 is driven immediately after the first heater energization without waiting for elapse of a time for cooling, the fine particle detection can be performed appropriately (without receiving the influence of a decrease in the volume resistivity of the insulating spacer 100 caused by an increase in the temperature thereof). Also, even when the insulation test was performed after the first heater energization without waiting for elapse of a time for cooling, it is possible to determine whether or not the insulation between the inner metallic member 20 and the outer metallic member 70 having had deteriorated as a result of adhesion of water to the gas contact surfaces 100m has recovered (without receiving the influence of a decrease in the volume resistivity of the insulating spacer 100 caused by an increase in the temperature thereof). Therefore, in the present Embodiment 2, a first cooling time for the first heater energization is set to “0” so that, after the first heater energization, the insulation test is performed (step T8 of FIG. 12) without waiting for elapse of a time for cooling. In the case where it is determined that the degree of insulation falls within the allowable range (specifically, the leak current Im is equal to or less than the reference value Ims), the fine particle sensor 10 is driven immediately (step T3 of FIG. 12), and the fine particle detection is performed (step T4 of FIG. 12).

Meanwhile, in the case where the above-described second heater energization is performed, as compared with the case where the first heater energization is performed, the increase in the temperature of the insulating spacer 100 is larger, and the decrease in the volume resistivity (volume specific resistance) of the insulating spacer 100 becomes larger. Therefore, immediately after the second heater energization is performed, the insulating spacer 100 may fail to appropriately provide electrical insulation between the inner metallic member 20 and the outer metallic member 70. In such a case, if the fine particle sensor 10 is driven, after performance of the second heater energization, so as to detect the amount of the fine particles S contained in the exhaust gas EG, there arises the possibility that the amount of the fine particles S contained in the exhaust gas EG cannot be detected appropriately.

In order to overcome such a drawback, in the fine particle detection system 301 of the present Embodiment 2, in the case where the fine particle sensor 10 is driven after the second heater energization, the fine particle sensor 10 is driven upon elapse of a second cooling time t2 after the end of the second heater energization (step T13 of FIG. 12). As a result of elapse of the second cooling time t2 after the end of the second heater energization, the temperature of the insulating spacer 100 drops, whereby the volume resistivity (volume specific resistance) of the insulating spacer 100 can be recovered. As a result, the insulating spacer 100 can appropriately provide electrical insulation between the inner metallic member 20 and the outer metallic member 70. By driving the fine particle sensor 10 after that, the amount of the fine particles S contained in the exhaust gas EG can be detected appropriately.

Notably, the “second cooling time t2” is a “cooling time set in accordance with the conditions of energization of the spacer heater 105 by the second heater energization (for example, the duty ratio of the PWM control performed by the first heater energization circuit 223),” and is a cooling time set in advance for the second heater energization. In the present Embodiment 2, the “second cooling time t2” is set to a time (for example, 10 minutes) within which the temperature of the insulating spacer 100 having elevated due to the second heater energization is expected to drop to the temperature before performance of the second heater energization.

Next, the flow of the fine particle detection according to the present Embodiment 2 will be described. FIG. 12 is a flowchart showing the flow of the fine particle detection according to the present Embodiment 2. Notably, step T14 which is shown by a broken line in FIG. 12 is a process which is performed in Modification 1 to be described later and which is not performed in the present Embodiment 2.

When the operation of the engine is started as a result of the key switch (not shown) of the engine being turned on, in step T1, the microprocessor 221 detects the leak current Im as in the case of step S1 of Embodiment 1. Subsequently, in step T2, the microprocessor 221 determines whether or not the magnitude of the leak current Im falls within the allowable range (specifically, is equal to or less than the reference value Ims set in advance) as in the case of step S2 of Embodiment 1.

In the case where the microprocessor 221 determines in step T2 that the leak current Im is equal to or less than the reference value Ims (YES), the microprocessor 221 proceeds to step T3 so as to drive the fine particle sensor 10 as in the case of step S3 of Embodiment 1. Subsequently, the microprocessor 221 proceeds to step T4 so as to detect the amount of the fine particles S contained in the exhaust gas EG as in the case of step S4 of Embodiment 1.

Meanwhile, in the case where the microprocessor 221 determines in step T2 that the leak current Im is greater than the reference value Ims (NO), the microprocessor 221 proceeds to step T5 so as to start the first heater energization. Specifically, in response to an instruction from the microprocessor 221, the first heater energization circuit 223 supplies electricity to the spacer heater 105 through the PWM control for executing the first heater energization, to thereby raise the temperature of the spacer heater 105 to a temperature at which water adhering to the gas contact surfaces 100m is removed (for example, a temperature within the range of 100° C. to 150° C.). In the present Embodiment 2, the first heater energization is executed, with the duty ratio of the PWM control performed by the first heater energization circuit 223 being set such that the effective voltage applied to the spacer heater 105 becomes a “value which can raise the temperature of the spacer heater 105 to a temperature at which water adhering to the gas contact surfaces 100m is removed (for example, a temperature within the range of 100° C. to 150° C.).”

After that, in step T6, the microprocessor 221 determines whether or not a predetermined time has elapsed after the start of the supply of electricity from the first heater energization circuit 223 to the spacer heater 105 (for example, the microprocessor 221 determines whether or not the period of time during which electricity is supplied from the first heater energization circuit 223 to the spacer heater 105 has reached the first energization time set in advance). Notably, the predetermined time (first energization time) is preferably set to, for example, a time which is necessary and sufficient for evaporation of water adhering to the gas contact portion 100s.

In the case where the microprocessor 221 determines in step T6 that the predetermined time has elapsed after the start of the energization (YES), the microprocessor 221 proceeds to step T7. In step T7, in response to an instruction from the microprocessor 221, the first heater energization circuit 223 ends the supply of electricity to the spacer heater 105. In the case where the microprocessor 221 determines in step T6 that the predetermined time has not yet elapsed after the start of the supply of electricity to the spacer heater 105 (NO), the microprocessor 221 repeats the determination process of step T6 until the predetermined time elapses. As a result of performance of the processes of steps T5 to T7, the first heater energization is executed, whereby the water adhering to the gas contact surfaces 100m of the insulating spacer 100 is removed (evaporated).

When the microprocessor 221 ends the first heater energization in step S7 by ending the supply of electricity to the spacer heater 105, the microprocessor 221 proceeds to step T8 so as to detect the leak current Im as in the case of the above-described step T1. Subsequently, the microprocessor 221 proceeds to step T9 so as to determine whether or not the magnitude of the detected leak current Im falls within the allowable range (specifically, is equal to or less than the reference value Ims set in advance) as in the case of the above-described step T2.

In the case where the microprocessor 221 determines in step T9 that the leak current Im is equal to or less than the reference value Ims (YES), the microprocessor 221 proceeds to steps T3 and T4, and performs the above-described processes so as detect the amount of the fine particles S contained in the exhaust gas EG.

Meanwhile, in the case where the microprocessor 221 determines in step T9 that the leak current Im is greater than the reference value Ims (NO), the microprocessor 221 proceeds to step T10 so as to start the second heater energization. Specifically, in response to an instruction from the microprocessor 221, the first heater energization circuit 223 supplies electricity to the spacer heater 105 through the PWM control for executing the second heater energization (PWM control in which the duty ratio is greater than that in the PWM control for the above-mentioned first heater energization), to thereby raise the temperature of the spacer heater 105 to a temperature for removal of the foreign substances (soot, oil, or the like) which have adhered to the contact surfaces 100m and cannot be removed by the first heater energization (a temperature higher than the temperature achieved by the first heater energization; for example, a temperate within the range of 500° C. to 600° C.) In the present Embodiment 2, the second heater energization is executed, with the duty ratio of the PWM control performed by the first heater energization circuit 223 being set such that the effective voltage applied to the spacer heater 105 becomes a “value which can raise the temperature of the spacer heater 105 to a temperature at which the foreign substances (soot, oil, or the like) which have adhered to the contact surfaces 100m and cannot be removed by the first heater energization are removed (for example, a temperature within the range of 500° C. to 600° C.)

After that, in step T11, the microprocessor 221 determines whether or not a predetermined time has elapsed after the start of the supply of electricity from the first heater energization circuit 223 to the spacer heater 105 (for example, the microprocessor 221 determines whether or not the period of time during which electricity is supplied from the first heater energization circuit 223 to the spacer heater 105 has reached the second energization time set in advance). Notably, the predetermined time (second energization time) is preferably set to, for example, a time which is necessary and sufficient for removing (burning out) soot adhering to the gas contact portion 100s.

In the case where the microprocessor 221 determines in step T11 that the predetermined time has elapsed after the start of the energization (YES), the microprocessor 221 proceeds to step T12. In step T12, in response to an instruction from the microprocessor 221, the first heater energization circuit 223 ends the supply of electricity to the spacer heater 105. In the case where the microprocessor 221 determines in step T11 that the predetermined time has not yet elapsed after the start of the supply of electricity to the spacer heater 105 (NO), the microprocessor 221 repeats the determination process of step T11 until the predetermined time elapses. As a result of performance of the processes of steps T10 to T12, the second heater energization is executed, whereby the foreign substances (soot, etc.) adhering to the gas contact surfaces 100m of the insulating spacer 100 (foreign substances which were not removed by the first heater energization) are removed. Therefore, it is possible to recover the insulation properties of the insulating spacer 100 (the insulation properties of the gas contact surfaces 100m) having deteriorated as a result of adhesion of the foreign substances (soot, etc.) to the gas contact surfaces 100m.

When the microprocessor 221 ends the second heater energization in step T12 by ending the supply of electricity to the spacer heater 105, the microprocessor 221 proceeds to step T13 so as to determine whether or not the second cooling time t2 has elapsed after the end of the second heater energization. In the case where the microprocessor 221 determines that the second cooling time t2 has not yet elapsed (NO), the microprocessor 221 repeats the determination process of step T13 until the second cooling time t2 elapses. After that, in the case where the microprocessor 221 determines that the second cooling time t2 has elapsed (YES), the microprocessor 221 proceeds to steps T3 and T4 and detects the amount of the fine particles S contained in the exhaust gas EG by performing the above-described process.

As described above, in the present Embodiment 2 as well, after the operation of the engine (internal combustion engine) is started, a test is performed, prior to the start of driving of the fine particle sensor 10, so as to determine whether or not the degree of insulation between the inner metallic member 20 and the outer metallic member 70 falls within the allowable range (specifically, whether or not the leak current Im flowing between the inner metallic member 20 and the outer metallic member 70 is equal to or less than the reference value Ims).

In the case where it is determined that the degree of insulation falls within the allowable range (specifically, the leak current Im is equal to or less than the reference value Ims), the amount of the fine particles S is detected by driving the fine particle sensor 10. Also, in the case where it is determined that the degree of insulation falls outside the allowable range (specifically, the leak current Im is greater than the reference value Ims) and it is determined after performance of the first heater energization that the degree of insulation falls within the allowable range, after that, the amount of the fine particles S is detected by driving the fine particle sensor 10.

Meanwhile, in the case where it is determined that the degree of insulation falls outside the allowable range even after performance of the first heater energization, after foreign substances such as soot are removed from the gas contact surfaces 100m of the insulating spacer 100 by performing the second heater energization and the insulation properties (volume resistivity) of the insulating spacer 100 recover as a result of elapse of the second cooling time t2, the fine particle sensor 10 is driven so as to detect the amount of the fine particles S.

Accordingly, in the fine particle detection system 301 of the present Embodiment 2, after the operation of the engine (internal combustion engine) is started, the amount of the fine particles S contained in the exhaust gas EG discharged from the engine can be detected appropriately.

Notably, the microprocessor 221 performing the processes of steps T1 and T2 and the signal current detection circuit 230, and the microprocessor 221 performing the processes of steps T8 and T9 and the signal current detection circuit 230 correspond to the “insulation test means.” Also, the microprocessor 221 performing the process of step T3, the ion source power supply circuit 210, and the auxiliary electrode power supply circuit 240 correspond to the “sensor drive means.” Also, the microprocessor 221 performing the processes of steps T5 to T7 and the first heater energization circuit 223, and the microprocessor 221 performing the processes of steps T10 to T12 and the first heater energization circuit 223 correspond to the “heater energization means.”

### (Modification 1)

Next, Modification 1 of the present invention will be described. The present Modification 1 differs from Embodiment 2 in a portion of the flow of fine particle detection (accordingly the control program input to the microprocessor 221) and is the same as Embodiment 2 in other points. Therefore, the point different from that of Embodiment 2 will be mainly described, and the points identical with those of Embodiment 2 will not be described or will be described in a simplified manner.

As described above, in Embodiment 2, the first cooling time for the first heater energization is set to “0” so that, after the first heater energization, the insulation property test is performed without waiting for elapse of the cooling time, and in the case where it is determined that the degree of insulation falls within the allowable range (specifically, the leak current Im is equal to or less than the reference value Ims), the fine particle sensor 10 is immediately driven so as to perform the fine particle detection (see FIG. 12). The reason why such a process is possible is that, in Embodiment 2, the dimensions of the insulating spacer 100 (specifically, the thickness of the insulating spacer 100 intervening between the inner metallic member 20 and the outer metallic member 70) are sufficiently large, so that even when the temperature of the insulating spacer 100 elevates as a result of performance of the first heater energization, the insulating spacer 100 can appropriately provide electrical insulation between the inner metallic member 20 and the outer metallic member 70 (in other words, the leak current Im becomes equal to or less than the reference value Ims) if the foreign substances are removed from the gas contact surfaces 100m of the insulating spacer 100.

In contrast, in a fine particle detection system 501 of the present Modification 1, the dimensions of the insulating spacer 100 (specifically, the thickness of the insulating spacer 100 intervening between the inner metallic member 20 and the outer metallic member 70) are “small, so that when the temperature of the insulating spacer 100 elevates as a result of performance of the first heater energization, the insulating spacer 100 cannot appropriately provide electrical insulation between the inner metallic member 20 and the outer metallic member 70 (in other words, the leak current Im becomes greater than the reference value Ims) even if the foreign substances are removed from the gas contact surfaces 100m of the insulating spacer 100.” Therefore, in the present Modification 1, after the first heater energization, it is necessary to wait until the insulation performance (volume resistivity) of the insulating spacer 100 recover as a result of elapse of the first cooling time t1. Notably, FIG. 12 (including step T14 denoted by a broken line) is a flowchart showing the flow of the fine particle detection according to the present Modification 1.

Specifically, in the present Modification 1, as shown by a broken line in FIG. 12, after having ended the first heater energization in step T7 by ending the supply of electricity to the spacer heater 105, the microprocessor 221 proceeds to step T14 so as to determine whether or not the first cooling time t1 has elapsed after the end of the first heater energization. In the case where the microprocessor 221 determines that the first cooling time t1 has not yet elapsed (NO), the microprocessor 221 repeats the determination process of step T14 until the first cooling time t1 elapses. After that, in the case where the microprocessor 221 determines that the first cooling time t1 has elapsed (YES), the microprocessor 221 proceeds to step T8 so as to detect the leak current Im. After that, in the case where the microprocessor 221 determines in step T9 that the magnitude of the detected leak current Im falls within the allowable range (specially, is equal to or less than the reference value Ims set in advance), the microprocessor 221 proceeds to steps T3 and T4 so as to detect the amount of the fine particles S contained in the exhaust gas EG.

Notably, the “first cooling time t1” is a “cooling time set in accordance with the conditions of energization of the spacer heater 105 by the first heater energization (for example, the duty ratio of the PWM control performed by the first heater energization circuit 223),” and is a cooling time set in advance for the first heater energization. This first cooling time t1 is preferably set to a time (for example, 5 minutes) within which the temperature of the insulating spacer 100 having elevated due to the first heater energization is expected to drop to the temperature before performance of the first heater energization.

Although the present invention has been described on the basis of Embodiments 1 and 2 and Modification 1, the present invention is not limited to the above-described embodiments, etc. and can be applied through proper modification without departing from the gist of the invention.

For example, in the embodiments, etc., the heat generation resistor 106 is formed of tungsten; however, the material of the heat generation resistor 106 is not limited thereto. Other metallic materials such as platinum and molybdenum and electrically conductive ceramic materials may be used.

Also, in the embodiments, etc., the flow described in the flowchart of FIG. 11 or FIG. 12 is exemplified as a specific flow of the fine particle detection. However, the flow of the fine particle detection is not limited thereto. For example, in the embodiments, etc., the leak current Im is measured only one time in step S1 (T1, T8), and a determination is made in step S2 (T2, T9) as to whether or not the magnitude of the leak current Im falls within the allowable range (specifically, is equal to or less than the reference value Ims set in advance). In the case where the magnitude of the leak current Im falls within the allowable range, the fine particle sensor 10 is driven in step S3 (T3). Namely, the determination as to whether or not the degree of insulation between the inner metallic member 20 and the outer metallic member 70 falls within the allowable range is made on the basis of the results of the single-time-measurement of the leak current Im.

However, the embodiments, etc. may be modified such that the leak current Im is measured a plurality of times, and the determination as to whether or not the degree of insulation between the inner metallic member 20 and the outer metallic member 70 falls within the allowable range is made on the basis of the results of the measurement performed the plurality of times. For example, the embodiments, etc. may be modified such that the leak current Im is measured three times, and in the case where the magnitude of the leak current Im falls within the allowable range (specifically, is equal to or less than the reference value Ims set in advance) in all the times (three times), it is determined that the degree of insulation between the inner metallic member 20 and the outer metallic member 70 falls within the allowable range, and the fine particle sensor 10 is driven in step S3 (T3). By making the determination as to whether or not the degree of insulation falls within the allowable range on the basis of the results of measurement of the leak current Im performed a plurality of times, the reliability of the insulation determination can be increased, whereby the reliability of the fine particle detection can be increased.

Also, in Embodiment 2, the second heater energization is ended when the predetermined time (the second energization time) set in advance elapses after the start of the second heater energization (see steps T10 to T12 of FIG. 12). However, Embodiment 2 may be modified such that the measurement of the leak current Im (the process of step T1) and the determination as to whether or not the magnitude of the leak current Im falls within the allowable range (the process of step T2) are performed at fixed time intervals after the second heater energization is started, and the second heater energization is ended after the magnitude of the leak current Im is determined to fall within the allowable range.

Also, since the first heater energization and the second heater energization differ from each other in the conditions of energization of the spacer heater 105, the temperature of the insulating spacer 100 after the first heater energization differs from the temperature of the insulating spacer 100 after the second heater energization. Therefore, in Embodiment 2 and Modification 1, the cooling times (the first cooling time and the second cooling time) are set in accordance with the energization conditions for the respective heater energizations. However, the cooling time after the first heater energization and the cooling time after the second heater energization may be made equal to each other (equally set to a certain cooling time) irrespective of the energization conditions for the respective heater energizations. The “certain cooling time” in this case is preferably set to a time which is required after the second heater energization to recover the insulation performance (volume resistivity) of the insulating spacer 100 such that the inner metallic member 20 and the outer metallic member 70 are electrically insulated from each other appropriately by the insulating spacer 100.

### DESCRIPTION OF SYMBOLS

1, 301, 501: fine particle detection system
10: fine particle sensor
20: inner metallic member
25: gas introduction pipe (inner metallic member)
30: metallic shell (inner metallic member)
40: inner tube (inner metallic member)
50: inner-tube metal connection member (inner metallic member)
60: inner protector (inner metallic member)
60e: gas discharge opening
65: outer protector (inner metallic member)
65c: gas introduction opening
70: outer metallic member
80: metallic attachment member (outer metallic member)
90: outer tube (outer metallic member)
100: insulating spacer
100s: gas contact portion
100m: gas contact surface
101: spacer body
102: laminar heater portion
105: spacer heater (heater)
106: heat generation resistor
120: ceramic element
130: discharge electrode member
140: auxiliary electrode member
200: circuit section
210: ion source power supply circuit (sensor drive means)
221: microprocessor (insulation test means, sensor drive means, heater energization means)
223: first heater energization circuit (heater energization means)
230: signal current detection circuit (insulation test means)
240: auxiliary electrode power supply circuit (sensor drive means)
CP: ion
EP: exhaust pipe (gas flow pipe)
EG: exhaust gas (gas under measurement)
EGI: introduced gas
Is: signal current
PVE: ground potential
PV1: first potential
S: fine particle
SC: electrified fine particle

What is claimed is:

1. A fine particle detection system for detecting fine particles contained in a gas under measurement flowing through a gas flow pipe, comprising:
a fine particle sensor to be attached to the gas flow pipe maintained at a ground potential; and
sensor drive means for driving the fine particle sensor,
wherein the fine particle sensor comprises:
a tubular outer metallic member attached to the gas flow pipe to thereby be maintained at the ground potential,
an inner metallic member which is maintained at a first potential different from the ground potential and whose radially outer circumference is surrounded by the outer metallic member, and
a tubular insulating spacer disposed between the inner metallic member and the outer metallic member so as to electrically insulate the members from each other,
the insulating spacer including a gas contact portion having a gas contact surface which comes into contact with the gas under measurement flowing through the gas flow pipe, and a heater for heating the gas contact portion, and
the heater including a heat generation resistor embedded in the insulating spacer,
wherein the fine particle detection system comprises:
insulation test means for determining, through testing, whether or not the degree of insulation between the inner metallic member and the outer metallic member falls within an allowable range, and
heater energization means for energizing the heater to thereby cause the heat generation resistor to generate heat,
wherein in the case where it is determined by the insulation test means that the degree of insulation does not fall within the allowable range, the heater energization means performs heater energization for energizing the heater to thereby heat the gas contact portion,
in the case where it is determined by the insulation test means without performance of the heater energization that the degree of insulation falls within the allowable range, the sensor drive means drives the fine particle sensor after the determination, and
in the case where the heater energization is performed and the sensor drive means drives the fine particle sensor after the heater energization, the sensor drive means drives the fine particle sensor after a certain cooling time or a cooling time set in accordance with conditions of the energization of the heater by the heater energization elapses after completion of the heater energization.

2. The fine particle detection system according to claim 1, wherein the fine particle sensor generates gaseous discharge as a result of being driven by the sensor drive means, causes ions generated by means of the gaseous discharge to adhere to the fine particles contained in the gas under measurement to thereby produce electrified fine particles, and detects the amount of the fine particles contained in the gas under measurement through use of a signal current flowing between the first potential and the ground potential in accordance with the amount of the electrified fine particles.

3. The fine particle detection system according to claim 1, wherein
the gas flow pipe is an exhaust pipe of an internal combustion engine,
the gas under measurement is exhaust gas, and
the insulation test means determines whether or not the degree of insulation between the inner metallic member and the outer metallic member falls within the allowable range in a period between a time when operation of the internal combustion engine is started and a time when the drive of the fine particle sensor by the sensor drive means is started.

4. The fine particle detection system according to claim 2, wherein
the gas flow pipe is an exhaust pipe of an internal combustion engine,
the gas under measurement is exhaust gas, and
the insulation test means determines whether or not the degree of insulation between the inner metallic member and the outer metallic member falls within the allowable range in a period between a time when operation of the internal combustion engine is started and a time when the drive of the fine particle sensor by the sensor drive means is started.
